(19) United States
(12) Patent Application Publication
(10) Pub. No.: US 2020/0183183 A1
(43) Pub. Date: Jun. 11, 2020

(54) IMAGE DISPLAY APPARATUS

(71) Applicant: SONY CORPORATION, TOKYO (JP)

(72) Inventor: YUSUKE OYAMA, KANAGAWA (JP)

(21) Appl. No.: 16/463,210

(22) PCT Filed: Dec. 18, 2017
(86) PCT No.: PCT/JP2017/045302

§ 371 Date: May 22, 2019

(30) Foreign Application Priority Data
Dec. 26, 2016 (JP) 2016-250891

(51) Int. Cl. G02B 30/56; G02B 27/14

(52) U.S. Cl. CPC G02B 30/56; G06F 3/042; G02B 27/14

(57) ABSTRACT

An image display apparatus according to an embodiment of the present technology includes an emitter, an image-forming element, a first reflector element, and a second image-forming element. The emitter emits an image light beam. The image-forming element forms an image of the entering image light beam as a mid-air image. The first reflector element includes a first surface and a second surface and that causes at least part of the image light beam, which is emitted from the emitter and enters the first surface, to pass therethrough and reflects at least part of the image light beam, which enters the second surface, to the image-forming element. The second reflector element reflects at least part of the image light beam, which enters the first surface and passes through the first reflector element, to the second surface of the first reflector element.

### TECHNICAL FIELD

The present technology relates to an image display apparatus that displays a mid-air image.

### BACKGROUND ART

In recent years, a technology of displaying an image floating in the air has been developed. For example, an image of an operation screen, video content, or the like is formed and displayed as a mid-air image in a space viewed by a user. With this configuration, a mid-air display in which a display is floating in a space where nothing exists and the like can be realized.

Patent Literature 1 has described an image-forming element that displays an image of an object in a space. Inside this image-forming element, a large number of flat light reflectors orthogonal to one another are arranged at constant pitches. Part of light entering the image-forming element is reflected by the flat light reflectors orthogonal to one another twice. Then, the reflected light is emitted from a surface opposite to an incident surface plane-symmetrically with respect to the image-forming element. With this configuration, a real image of the object is formed at a position plane-symmetric to the object across the image-forming element. As a result, the user can view a mid-air image of the object (e.g., paragraphs [0034] to [0038] of specification and FIG. 5 of Patent Literature 1).

### CITATION LIST

### Patent Literature

Patent Literature 1: Japanese Patent Application Laid-open No. 2011-175297

### DISCLOSURE OF INVENTION

### Technical Problem

The display technology using the mid-air image is expected to be applied in various fields such as amusement, advertisement, and medical fields. It is desirable to provide a technology capable of downsizing the apparatus.

In view of the above-mentioned circumstances, it is an object of the present technology to provide a compact image display apparatus capable of displaying a mid-air image.

### Solution to Problem

In order to accomplish the above-mentioned object, an image display apparatus according to an embodiment of the present technology includes an emitter, an image-forming element, a first reflector element, and a second image-forming element.

The emitter emits an image light beam.

The image-forming element forms an image of the entering image light beam as a mid-air image.

The first reflector element includes a first surface and a second surface and that causes at least part of the image light beam, which is emitted from the emitter and enters the first surface, to pass therethrough and reflects at least part of the image light beam, which enters the second surface, to the image-forming element.

The second reflector element reflects at least part of the image light beam, which enters the first surface and passes through the first reflector element, to the second surface of the first reflector element.

In this image display apparatus, the image light beam entering the first surface of the first reflector element and passing through the first reflector element are reflected by the second reflector element to the second surface of the first reflector element. The image light beam reflected to the second surface of the first reflector element is reflected by the second surface to the image-forming element. By configuring the optical path of the image light beam in this manner, downsizing of the apparatus can be achieved. As a result, a compact image display apparatus capable of displaying a mid-air image can be realized.

The second reflector element may reflect at least part of the image light beam, which enters the first surface of the first reflector element, passes through the first reflector element, and is emitted in a predetermined direction, in the predetermined direction.

In this image display apparatus, the image light beam emitted from the first reflector element is turned back and reflected by the second reflector element in the same direction. With this configuration, downsizing of the apparatus can be achieved.

The emitter may emit the image light beam to the first surface of the first reflector element in the predetermined direction.

With this configuration, the optical path of the image light beam from the emitter to the second surface of the first reflector element, which it enters, can be configured in a substantially straight line. As a result, downsizing of the apparatus can be achieved.

The emitter, the first reflector element, and the second reflector element may be arranged in the stated order in the predetermined direction.

The emitter, the first reflector element, and the second reflector element are arranged in line along the predetermined direction. Therefore, simplification of the apparatus configuration and downsizing of the apparatus can be sufficiently achieved.

The image-forming element may include an incident surface, which the image light beam enters. In this case, the predetermined direction may be a direction parallel to the incident surface.

With this configuration, the emitter, the first reflector element, and the second reflector element are arranged in line along the incident surface. Therefore, the thickness and the like of the apparatus can be sufficiently reduced.

The image display apparatus may further include one or more other emitters that each emit another image light beam.

With this configuration, images of a plurality of image light beams can be formed, and superimposition of the mid-air images and the like can be performed.

The one or more other emitters may include the other emitter that is arranged on a side opposite to the first reflector element of the second reflector element and emits the other image light beam to the second reflector element in the predetermined direction. In this case, the second reflector element may cause at least part of the other image light beam emitted by the other emitter to pass therethrough and emit the at least part of the other image light beam to the second surface of the first reflector element.

With this configuration, the mid-air image of the other image light beam can be displayed by using a part of the optical path of the image light beam. As a result, the mid-air images can be displayed to be superimposed on each other while the apparatus size is reduced.

The one or more other emitters may include the other emitter that is arranged between the first reflector element and the second reflector element, emits the other image light beam to the second reflector element in the predetermined direction, and causes the image light beam passing through the first reflector element and the other image light beam reflected by the second reflector element to pass therethrough.

With this configuration, the other emitter that emits the other image light beam on the optical path of the image light beam can arranged. As a result, the mid-air images can be displayed to be superimposed on each other while the apparatus size is reduced.

The one or more other emitters may include the other emitter that is arranged on a side opposite to the image-forming element with respect to the first reflector element and emits the other image light beam to the first surface of the first reflector element in an emission direction of the image light beam reflected by the second surface of the first reflector element.

With this configuration, the mid-air image of the other image light beam can be displayed by using a part of the optical path of the image light beam. As a result, the mid-air images can be displayed to be superimposed on each other while the apparatus size is reduced.

The image display apparatus may further include a changer that changes an image-forming position of the mid-air image which is formed by the image-forming element.

With this configuration, the image-forming position of the mid-air image can be changed, and the position of the mid-air image and the like can be controlled with high precision.

The image-forming element may form the mid-air image at a position depending on an incident position of the image light beam which enters the image-forming element and an optical path length of the image light beam from the emitter to the image-forming element. In this case, the changer may be capable of changing at least one of the incident position of the image light beam or the optical path length of the image light beam.

By changing the incident position of the image light beam and the optical path length of the image light beam, the position, the protruding distance, and the like of the mid-air image can be controlled with high precision.

The changer may be capable of changing a position of at least one of the emitter, the first reflector element, or the second reflector element.

With this configuration, the incident position and the optical path length of the image light beam can be easily changed, and the position, the protruding distance, and the like of the mid-air image can be controlled with high precision.

The changer may move at least one of the emitter, the first reflector element, or the second reflector element in the predetermined direction.

With this configuration, the protruding distance of the mid-air image and the like can be easily controlled by changing the distance and the like of the emitter, the first reflector element, and the second reflector element which are arranged in line, for example.

The changer may be capable of changing at least one of an emission direction of the image light beam of the emitter, an angle of reflection of the image light beam of the first reflector element, or an angle of reflection of the image light beam of the second reflector element.

With this configuration, the incident position and the like of the image light beam can be easily changed, and the image-forming position of the mid-air image can be controlled with high precision.

The image display apparatus may further include another reflector element that is arranged between the first reflector element and the second reflector element, reflect part of the image light beam, which passes through the first reflector element, to the image-forming element, and cause other part of light the image light beam, which passes through the first reflector element, to pass therethrough.

With this configuration, it is possible to cause a plurality of mid-air images to be formed from a single image light beam.

The image display apparatus may further include a plurality of image display units, each of which is a unit including the emitter and the first reflector element and the second reflector element for guiding the image light beam emitted by the emitter to the image-forming element, the plurality of image display units being arranged using a position of the image-forming element as a reference.

With this configuration, downsizing of the apparatus can be achieved in such a manner that the plurality of image display units are arranged using the position of the image-forming element as a reference. As a result, a compact apparatus capable of displaying a plurality of mid-air images can be realized.

The plurality of image display units may each include the image-forming element for forming an image of the image light beam emitted by the emitter as the mid-air image. In this case, the plurality of image display units may be arranged in such a manner that the mid-air images respectively formed by the plurality of image display units are superimposed on each other at a predetermined angle, using a predetermined reference point as a center.

With this configuration, the range of angle in which the mid-air image can be visually recognized can be extended by superimposing the plurality of mid-air images on each other at the predetermined angle, for example.

The image display apparatus may further include a sensor unit that detects a touch operation on the mid-air image.

With this configuration, a touch operation on the mid-air image can be performed, and an operation screen to be displayed in the air and the like can be realized.

The changer may include an external optical unit which is arranged on an optical path of the image light beam which is emitted from the image-forming element.

With this configuration, the image-forming position, the size, and the like of the mid-air image can be controlled with high precision.

The changer may include an internal optical unit which is arranged on an optical path of the image light beam from the emitter to the image-forming element.

With this configuration, the image-forming position, the size, and the like of the mid-air image can be controlled with high precision.

### Advantageous Effects of Invention

As described above, in accordance with the present technology, a compact image display apparatus capable of displaying a mid-air image can be provided. It should be noted that the effects described here are not necessarily limitative and any effect described in the present disclosure may be provided.

### BRIEF DESCRIPTION OF DRAWINGS

FIG. 1 A schematic diagram showing a configuration example of a mid-air image display apparatus according to a first embodiment.

FIG. 2 A schematic diagram showing arrangement of a first display and first and second transmissive mirrors.

FIG. 3 A schematic diagram showing a configuration inside an apparatus which is shown as a comparative example.

FIG. 4 A schematic diagram for describing arrangement of a plurality of displays.

FIG. 5 A schematic diagram showing an example of an operation of an actuator.

FIG. 6 A schematic diagram showing an example of the operation of the actuator.

FIG. 7 A schematic diagram showing an example of the operation of the actuator.

FIG. 8 A schematic diagram showing an example of the operation of the actuator.

FIG. 9 A schematic diagram showing an example of a mid-air image displayed in accordance with the operation of the actuator.

FIG. 10 A schematic diagram for describing an optical path in an image-forming optical system.

FIG. 11 A diagram for describing a lens unit arranged on an optical path of a first image light beam emitted from an optical image-forming element.

FIG. 12 A schematic diagram for describing a configuration in which the image-forming optical system is movable.

FIG. 13 A schematic diagram showing another configuration example of the image-forming optical system.

FIG. 14 A schematic diagram showing another configuration example of the image-forming optical system.

FIG. 15 A schematic diagram showing a configuration example in a case where lenses are arranged inside the apparatus.

FIG. 16 A schematic diagram for describing a lens unit arranged inside the apparatus.

FIG. 17 A schematic diagram showing another configuration example of an emission optical system.

FIG. 18 A schematic diagram showing a configuration example of a mid-air image display apparatus according to a second embodiment.

FIG. 19 A schematic diagram showing a configuration example of the mid-air image display apparatus according to the second embodiment.

FIG. 20 A schematic diagram showing a configuration example of a mid-air image display apparatus according to a third embodiment.

FIG. 21 A schematic diagram for describing how the mid-air image displayed at a reference point is seen.

FIG. 22 A schematic diagram showing another configuration example of a mid-air image display unit.

FIG. 23 A schematic diagram showing another configuration example of the mid-air image display unit.

FIG. 24 A schematic diagram showing a configuration example of a mid-air image display apparatus according to another embodiment.

### MODE(S) FOR CARRYING OUT THE INVENTION

Hereinafter, embodiments according to the present technology will be described with reference to the drawings.

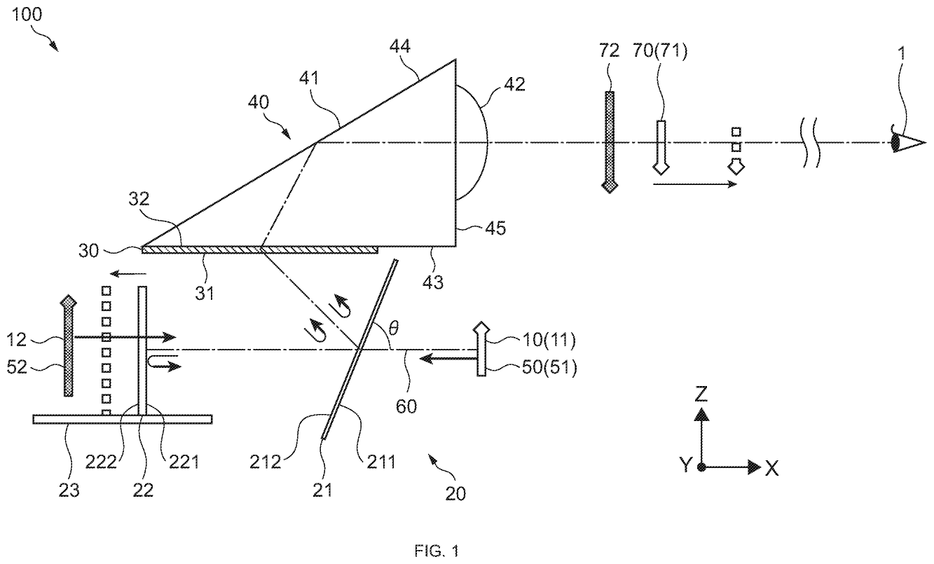

### First Embodiment

[Configuration of Mid-Air Image Display Apparatus] FIG. 1 is a schematic diagram showing a configuration example of a mid-air image display apparatus according to a first embodiment of the present technology. A mid-air image display apparatus 100 includes a plurality of displays 10, an emission optical system 20, an optical image-forming element 30, and an image-forming optical system 40. In this embodiment, the mid-air image display apparatus 100 corresponds to a mid-air image display apparatus.

The plurality of displays 10 each generate and display an original image on which an image to be displayed in the air is based. Light of respective pixels of the original image to be displayed on each of the displays 10 is emitted to a front side (display direction side) as an image light beam 50 that constitutes the image. It should be noted that in FIG. 1, the display 10 and the image light beam 50 are schematically expressed as the same icon and the arrow shape of the display 10 (image light beam 50) represents an image size and upper and lower directions. The way of illustrating the display 10 is applied also in other figures.

A specific configuration of the display 10 is not limited. For example, any display apparatus using liquid-crystal, electro-luminescence (EL), or the like may be used. It should be noted that any device or mechanism capable of emitting the image light beam 50 may be used instead of the display 10. For example, a projector or the like including a liquid-crystal panel, a digital micromirror device (DMD), or the like may be used. Otherwise, any image display apparatus (image projection apparatus) may be used.

As shown in FIG. 1, in this embodiment, first and second displays 11 and 12 are provided as the plurality of displays 10. The first display 11 emits the image light beam 50 (hereinafter, referred to as first image light beam 51) in a predetermined direction which is substantially parallel to an incident surface 31 of the optical image-forming element 30. In the example shown in FIG. 1, XYZ-coordinates are set such that a plane direction of the incident surface 31 of the optical image-forming element 30 is an XY-plane direction. Then, the first image light beam 51 is emitted along an optical axis 60 extending in the X direction.

The second display 12 is arranged facing the first display 11 across the emission optical system 20 in the X direction. The second display 12 emits a second image light beam 52 toward the first display 11 in the X direction. The second image light beam 52 is emitted in a direction opposite to that of the first image light beam 51 along the optical axis 60 of the first image light beam 51.

In this embodiment, the first display 11 and the first image light beam 51 correspond to an emitter and an image light beam. The second display 12 and the second image light beam 52 correspond to another emitter and another image light beam.

The emission optical system 20 is an optical system that guides each image light beam 50 emitted by each display 10 to the optical image-forming element 30. As shown in FIG. 1, the emission optical system 20 is arranged between the first and second displays 11 and 12. The emission optical system 20 includes a first transmissive mirror 21, a second transmissive mirror 22, and an actuator 23.

The first transmissive mirror 21 has a plate shape and is arranged on the optical axis 60 on a front side of the first display 11. The first transmissive mirror 21 includes a first surface 211 and a second surface 212 opposite thereto. The first transmissive mirror 21 causes part of light entering each surface to pass therethrough and reflects other part of light. Light transmittance (reflectance) in the first and second surfaces 211 and 212 is not limited. For example, a half mirror or the like having a transmittance (reflectance) of about 50% may be used.

As shown in FIG. 1, the first transmissive mirror 21 is arranged tilted at a predetermined angle using the Y direction as an axis from a state in which the first and second surfaces 211 and 212 are arranged to be orthogonal to the optical axis 60. That is, assuming that the Z direction corresponds to the upper and lower directions, the first surface 211 facing the first display 11 is tilted to be directed downward. The second surface 212 is tilted to be directed to the optical image-forming element 30 arranged above.

Assuming that an angle formed by the first transmissive mirror 21 and the X direction as viewed in the Y direction is an angle of inclination θ, that angle of inclination θ is typically defined on the basis of mid-air image-forming efficiency of the optical image-forming element 30. The optical image-forming element 30 of this embodiment most efficiently forms an image of the image light beam 50 entering at an angle of about 45 degrees with respect to the incident surface 31 as a mid-air image 70. Therefore, the angle of inclination θ of the first transmissive mirror 21 is set to about 67.5 degrees such that the image light beam 50 enters the optical image-forming element 30 at the angle of about 45 degrees. As a matter of course, the present technology is not limited thereto.

The second transmissive mirror 22 has a plate shape and is arranged on the optical axis 60 of the first image light beam 51 passing through the first transmissive mirror 21. Therefore, in this embodiment, the display 10 (first display 11), the first transmissive mirror 21, and the second transmissive mirror 22 are arranged in the stated order in the X direction which is a direction of the optical axis 60. It should be noted that the second display 12 is also arranged on a rear side of the second transmissive mirror 22 (on a side opposite to the first display 11) in the X direction.

The second transmissive mirror 22 includes a first surface 221 directed to the first transmissive mirror 21 and a second surface 222 opposite thereto. The second transmissive mirror 22 causes part of light entering each surface to pass therethrough and reflects other part of light. Transmittance (reflectance) of the second transmissive mirror 22 is not limited. For example, a half mirror or the like may be used. As shown in FIG. 1, the second transmissive mirror 22 is arranged such that the first and second surfaces 221 and 222 are orthogonal to the optical axis 60.

In this embodiment, the first transmissive mirror 21 and the second transmissive mirror 22 respectively correspond to a first reflector element and a second reflector element. Specific material and the like of the first and second transmissive mirrors 21 and 22 are not limited. For example, a transparent member including plastic, glass, and the like on which a thin film including aluminum, silver, chromium, and the like is formed is used.

The actuator 23 is capable of changing respective positions of the display 10, the first transmissive mirror 21, and the second transmissive mirror 22. In this embodiment, the actuator 23 independently moves the display 10, the first transmissive mirror 21, and the second transmissive mirror 22 relative to one another in the direction (X direction) of the optical axis 60 of the first image light beam 51. Moreover, the actuator 23 is capable of changing the angle of inclination θ of the first transmissive mirror 21.

A specific configuration of the actuator 23 is not limited. For example, any moving mechanism such as a linear stage using a stepping motor or the like, any rotating mechanism using a gear mechanism or the like, or the like may be used. In this embodiment, the actuator 23 functions as an adjustment mechanism (changer) that changes an image-forming position of the mid-air image formed by the optical image-forming element 30.

The optical image-forming element 30 has a plate shape and is arranged such that the incident surface 31 and an emission surface 32 are substantially parallel to the direction (X direction) of the optical axis 60. The incident surface 31 of the optical image-forming element 30 is provided inside the apparatus in which the first and second displays 11 and 12 and the emission optical system 20 are housed. Then, the emission surface 32 is provided on a mid-air side to which a user's viewpoint 1 (line of sight) is directed. The optical image-forming element 30 forms an image of the image light beam entering the incident surface 31 from the inside of the apparatus, as the mid-air image 70 in the air.

In this embodiment, the optical image-forming element 30 having a structure in which pairs of minute reflection surfaces perpendicular to the incident surface 31 (emission surface 32) and orthogonal to one another are arranged in a matrix form at predetermined intervals in an in-plane direction of the incident surface 31 is used. Such a structure is realized by arranging a large number of flat light reflectors orthogonal to one another at constant pitches as described in Patent Literature 1, for example. Alternatively, a structure of a dihedral corner reflector in which reflection surfaces are formed at side surfaces of rectangular holes or the like may be used.

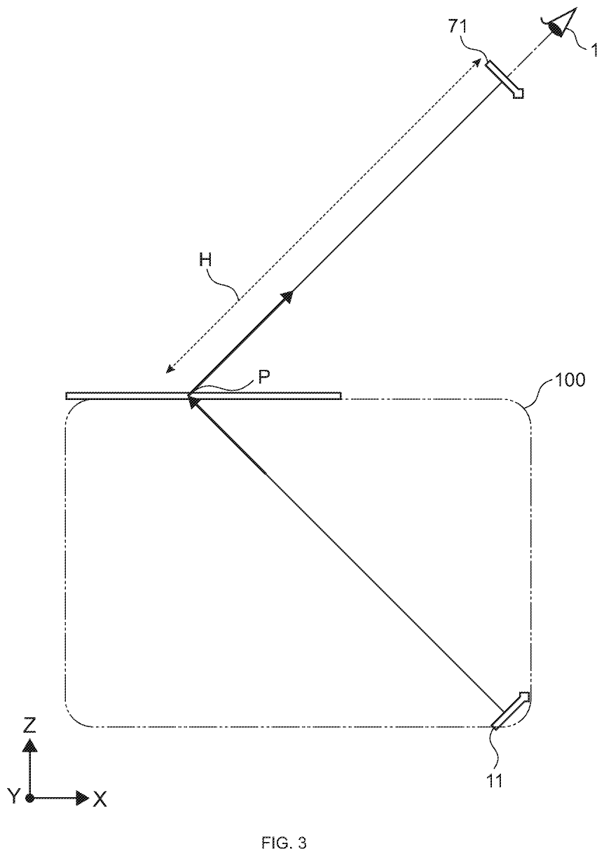

Part of the image light beam 50 entering from the incident surface 31 is reflected by the pair of minute reflection surfaces orthogonal to one another twice. Then, the reflected image light beam 50 is emitted from the emission surface 32. In this case, an incident direction and an emission direction of the image light beam 50 are plane-symmetric with respect to the optical image-forming element 30. Moreover, a distance by which the mid-air image 70 protrudes from the optical image-forming element 30 is substantially equal to an optical path length of the image light beam 50 from the display 10 to the optical image-forming element 30. For example, if the image light beam 50 emitted from the display 10 directly enters the optical image-forming element 30, an inverted real image (mid-air image 70) of the image light beam 50 is formed at a position plane-symmetric to the position of the display 10 across the optical image-forming element 30 (see FIG. 3).

The image-forming optical system 40 is arranged on an optical path of the image light beam 50 emitted from the optical image-forming element 30, which is on the mid-air side. In this embodiment, the image-forming optical system 40 includes a prism 41 and a lens unit 42. The prism 41 has a triangular prism shape. Three surfaces of prism 41, which are side surfaces of the triangular prism, are used as an incident surface 43, a reflection surface 44, and an emission surface 45. As shown in FIG. 1, the prism 41 is arranged such that the incident surface 43 is proximate to the emission surface 32 of the optical image-forming element 30.

The lens unit 42 is provided on the emission surface 45 of the prism 41. The lens unit 42 may be formed integrally with the prism 41 or may be connected to the emission surface 45 after those are separately provided. Material and the like of the prism 41 and the lens unit 42 are not limited. For example, glass, crystal, and the like may be used as appropriate. The image-forming optical system 40 functions as an external optical unit included in an adjustment function (changer).

The outline of display operations of a first mid-air image 71 and a second mid-air image 72 shown in FIG. 1 will be briefly described. The first image light beam 51 emitted from the first display 11 passes through the first transmissive mirror 21 and enters the second transmissive mirror 22 in the X direction. The first image light beam 51 turned back and reflected by the second transmissive mirror 22 is reflected by the first transmissive mirror 21 and enters the optical image-forming element 30. The first image light beam 51 emitted by the optical image-forming element 30 to the mid-air side travels through the prism 41 and is emitted via the lens unit 42 on the emission surface 45. With this configuration, the first mid-air image 71 is displayed.

The second image light beam 52 emitted from the second display 12 passes through the second transmissive mirror 22 and enters the first transmissive mirror 21 in the X direction. The second image light beam 52 is reflected by the first transmissive mirror 21 and enters the optical image-forming element 30. The second image light beam 52 emitted by the optical image-forming element 30 to the mid-air side travels through the prism 41 and is emitted via the lens unit 42 on the emission surface 45. With this configuration, the second mid-air image 72 is displayed.

Hereinafter, features of the respective sections of the mid-air image display apparatus 100 shown in FIG. 1 will be described in detail.

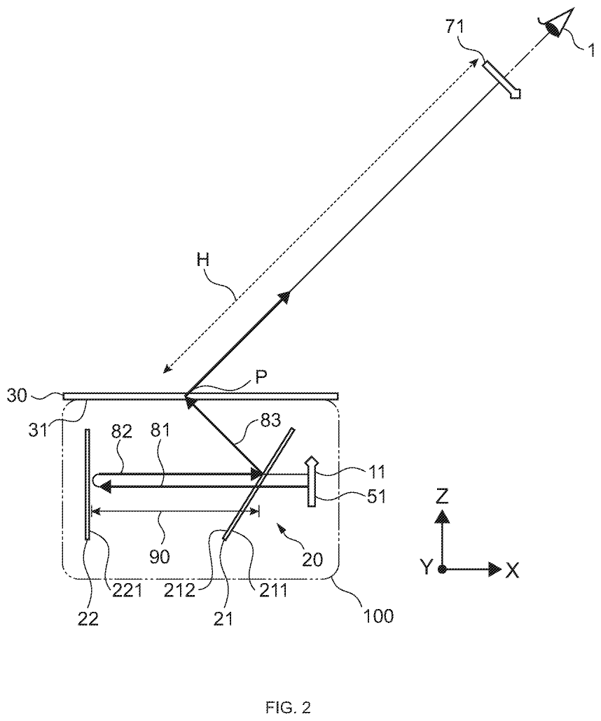

FIG. 2 is a schematic diagram showing arrangement of the first display 11 and the first and second transmissive mirrors 21 and 22. FIG. 3 is a schematic diagram showing a configuration inside an apparatus shown as a comparative example. It should be noted that in the configurations shown in FIGS. 2 and 3, the image-forming optical system 40 shown in FIG. 1 is omitted for easy understanding of the image-forming position of the first mid-air image 71 according to the arrangement of the first display 11 and the first and second transmissive mirrors 21 and 22.

As described above, in this embodiment, the first display 11, the first transmissive mirror 21, and the second transmissive mirror 22 are arranged in the stated order in the X direction which is the direction of the optical axis 60. The first image light beam 51 emitted from the first display 11 along the optical axis 60 enters the first surface 211 of the first transmissive mirror 21. Part of the first image light beam 51 entering the first surface 211 passes through the first transmissive mirror 21 and is emitted in the X direction as it is (optical path 81).

The first image light beam 51 passing through the first transmissive mirror 21 and emitted in the X direction enters the first surface 221 of the second transmissive mirror 22. Part of the first image light beam 51 entering the first surface 221 of the second transmissive mirror 22 is reflected in the X direction. That is, the first image light beam 51 is turned back and emitted by the second transmissive mirror 22 in the same direction as the incident direction (optical path 82).

The first image light beam 51 reflected by the second transmissive mirror 22 enters the second surface 212 of the first transmissive mirror 21. Part of the first image light beam 51 entering the second surface 212 of the first transmissive mirror 21 is reflected toward the incident surface 31 of the optical image-forming element 30 (optical path 83).

Part of the first image light beam 51 emitted from the first display 11 in this manner is guided to the optical image-forming element 30 while passing through the optical paths 81 to 83. An optical path length of the optical paths 81 to 83 is a distance obtained by summing up a distance from the first display 11 to the second transmissive mirror 22 (optical path 81), a distance from the second transmissive mirror 22 to the first transmissive mirror 21 (optical path 82), and a distance between the first transmissive mirror 21 and the optical image-forming element 30 (optical path 83).

The first image light beam 51 entering the incident surface 31 of the optical image-forming element 30 is emitted in an emission direction which is plane-symmetric to an incident direction to the incident surface 31 across the optical image-forming element 30. In this embodiment, the first image light beam 51 enters at the angle of about 45 degrees with respect to the incident surface 31. Therefore, the first image light beam 51 is emitted toward the mid-air side also at the angle of about 45 degrees and an image of the first image light beam 51 is formed as the first mid-air image 71.

A position at which the first mid-air image 71 is formed is a position depending on an incident position P of the first image light beam 51 which enters the optical image-forming element 30 and on the optical path length (optical paths 81+82+83) of the first image light beam 51 from the first display 11 to the optical image-forming element 30. In the example shown in FIG. 2, the first mid-air image 71 is formed at a position spaced apart from the incident position P of the first image light beam 51 in a direction of the angle of about 45 degrees by a distance substantially equal to the optical path length of the first image light beam 51. Therefore, a protruding distance H from the optical image-forming element 30 to the first mid-air image 71 is substantially equal to the optical path length of the first image light beam 51.

The comparative example shown in FIG. 3 has a configuration in a case of displaying the first mid-air image 71 at the same position without the emission optical system 20. Without the emission optical system 20, it is necessary to arrange the first display 11 at a position spaced apart from the same incident position P by the same optical path length (=optical paths 81+82+83) at the angle of about 45 degrees. Therefore, for ensuring a space for forming the straight optical path inside the apparatus, the size of the mid-air image display apparatus 100 in a vertical direction (Z direction) and a horizontal direction (X direction) becomes very large.

In contrast, in the configuration according to this embodiment which is shown in FIG. 2, a turned-back optical path 90 on which the first image light beam 51 travels in a reciprocating manner is configured by the first display 11, the first transmissive mirror 21, and the second transmissive mirror 22 which are arranged in a straight line. Therefore, a distance twice as large as a distance by which the turned-back optical path 90 is configured (distance between the first and second transmissive mirrors 22 and 21) can be added as the optical path length. With this configuration, the space necessary for forming the optical path of the first image light beam 51 can be sufficiently reduced, and the size of the mid-air image display apparatus 100 can be sufficiently reduced. As a result, a compact mid-air image display apparatus 100 capable of displaying the mid-air image can be realized.

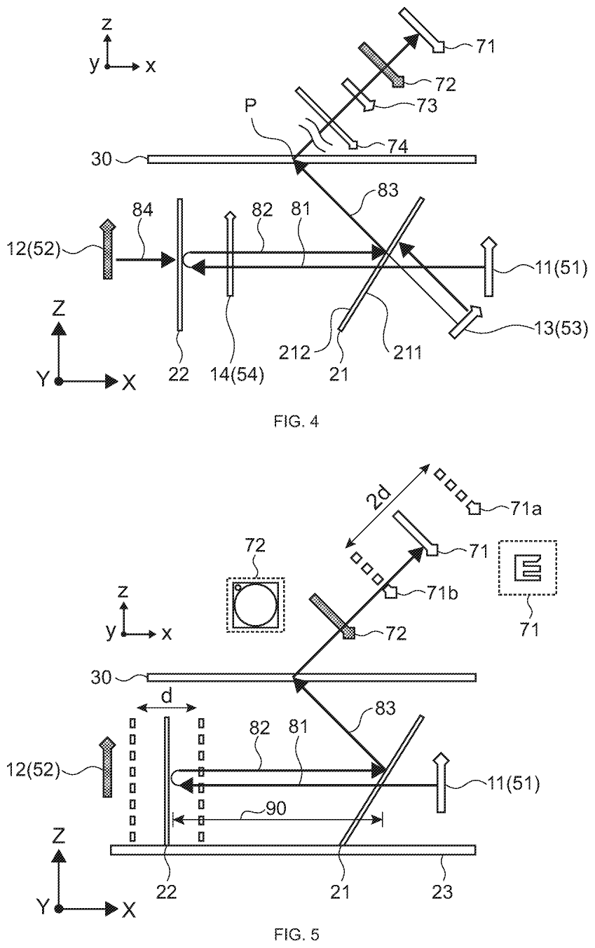

FIG. 4 is a schematic diagram for describing arrangement of the plurality of displays 10. In FIG. 4, the image-forming optical system 40 shown in FIG. 1 is omitted.

As shown in FIG. 1, in this embodiment, the first and second displays 11 and 12 are provided. The first and second displays 11 and 12 are arranged facing each other across the emission optical system 20 in the X direction.

The second display 12 is arranged on the rear side of the second transmissive mirror 22 (on a side opposite to the first transmissive mirror 21) such that the optical path of the second image light beam 52 is substantially equal to the optical path 82 of the first image light beam 51. The second image light beam 52 travelling on the optical path 82 is reflected by the first transmissive mirror 21 to the optical image-forming element 30. Then, the reflected second image light beam 52 enters the optical image-forming element 30 at substantially the same incident position P as the first image light beam 51. That is, the second image light beam 52 travels on the same optical paths (optical paths 82 and 83) as the first image light beam 51 and enters the optical image-forming element 30.

The second image light beam 52 entering the optical image-forming element 30 is emitted to the mid-air side in substantially the same emission direction as the first image light beam 51 and an image of second image light beam 52 is formed as the second mid-air image 72. A protruding distance of the second mid-air image 72 is substantially equal to an optical path length from the second display 12 to the optical image-forming element 30. Therefore, a distance obtained by summing up a distance (optical path 84) from the second display 12 to the second transmissive mirror 22, a distance (optical path 82) from the second transmissive mirror 22 to the first transmissive mirror 21, and a distance (optical path 83) from the first transmissive mirror 21 to the optical image-forming element 30 is the protruding distance of the second mid-air image 72.

In this embodiment, the optical path length of the second image light beam 52 is set to be shorter than the optical path length of the first image light beam 51. Therefore, as compared to the first mid-air image 71, the protruding distance of the second mid-air image 72 is shorter and the second mid-air image 72 is formed such that the second mid-air image 72 is closer to the optical image-forming element 30 than the first mid-air image 71 is. As viewed from the user, the second mid-air image 72 is displayed on the farther side (rear side) of the first mid-air image 71. With this configuration, it is possible to display an image in which the first mid-air image 71 and the second mid-air image 72 are superimposed on each other. For example, a high-level viewing experience can be provided.

By emitting another image light beam on the optical path, which has already been formed in the above-mentioned manner, it is possible to cause the other image light beam to enter the optical image-forming element 30 by using a part of that optical path. With this configuration, a member and the like for forming a new optical path become unnecessary, and other mid-air images can be easily displayed. Moreover, it is possible to easily cause an image in which a plurality of mid-air images are superimposed on one another to be displayed.

As shown in FIG. 4, it is also possible to arrange a third display 13 on a lower side of the first transmissive mirror 21 (on a side opposite to the optical image-forming element 30).

The third display 13 emits a third image light beam 53 to the first surface 211 of the first transmissive mirror 21 in an emission direction of the first image light beam 51 reflected by the second surface 212 of the first transmissive mirror 21 (incident direction to the optical image-forming element 30). That is, the third display 13 is arranged such that the third image light beam 53 passing through the first transmissive mirror 21 travels on the optical path 83 of the first image light beam 51.

With this configuration, the third image light beam 53 entering the optical image-forming element 30 is emitted to the mid-air side in an emission direction substantially similar to those of the first and second image light beams 51 and 52 and an image of the third image light beam 53 is formed as a third mid-air image 73. A protruding distance of the third mid-air image 73 is substantially equal to an optical path length from the third display 13 to the optical image-forming element 30. By adjusting a position of the third display 13 as appropriate, an image-forming position of the third mid-air image 73 can be adjusted and desired superimposed images can be displayed in the air. It should be noted that the third display 13 and the third image light beam 53 correspond to the other emitter and the other image light beam.

As shown in FIG. 4, it is also possible to arrange another display on the optical path of the image light beam 50, blocking the optical path.

For example, in the example shown in FIG. 4, a fourth display 14 is arranged on the optical paths 81 and 82 between the first and second transmissive mirrors 21 and 22. The fourth display 14 is a transmissive display and is capable of causing at least part of light entering it to pass therethrough.

The fourth display 14 emits a fourth image light beam 54 to the second transmissive mirror 22 in the X direction. The fourth image light beam 54 is emitted to travel on the optical path 81 of the first image light beam 51. Part of the fourth image light beam 54 is reflected by the second transmissive mirror 22 and passes through the fourth display 14. Then, it travels on the optical paths 82 and 83 and enters the optical image-forming element 30. The fourth image light beam 54 entering the optical image-forming element 30 is emitted to the mid-air side in an emission direction substantially similar to those of the first and second image light beams 51 and 52 and an image of the fourth image light beam 54 is formed as a fourth mid-air image 74.

By using the transmissive display, another display can be arranged on the optical path of the image light beam, which has already been formed. Then, using a part of that optical path, it is possible to cause the other image light beam to enter the optical image-forming element 30 at substantially the same incident position P. With this configuration, a member and the like for forming a new optical path become unnecessary, and other mid-air images can be easily displayed.

The fourth display 14 can be arranged not only at the position illustrated in FIG. 4, but also at a position between the optical image-forming element 30 and the first transmissive mirror 21 or any other position on the optical path. It should be noted that the fourth display 14 and the fourth image light beam 54 correspond to the other emitter and the other image light beam.

As described above, the plurality of mid-air images can be easily superimposed on one another by utilizing a part of the optical path of the first image light beam 51 from the first display 11 to the optical image-forming element 30. An apparatus configuration having a very high extensibility can be thus realized. For example, the image in which the four mid-air images are superimposed on one another can be displayed by arranging the first display 11 to the fourth display 14. With this configuration, for example, the user can view a stereoscopic mid-air video like a 3D-TV with naked eyes, and a high-level viewing experience can be provided.

Moreover, an optical system and the like for guiding the other image light beam to the optical image-forming element 30 do not need to be newly added. Therefore, the apparatus size can be sufficiently reduced. As a result, a compact mid-air image display apparatus 100 capable of displaying the mid-air image can be realized.

In this embodiment, the turned-back optical path 90 includes the first display 11, the first transmissive mirror 21, and the second transmissive mirror 22 which are arranged in the straight line. Therefore, the plurality of displays 10 can be easily arranged in accordance with various arrangement manners while the apparatus size is reduced.

It should be noted that the present technology is not limited to the case where the other image light beam is guided to the same incident position on the optical image-forming element 30 by utilizing a part of the optical path, which has already been formed. For example, it is also possible to cause the other image light beam to enter the optical image-forming element 30 at a position slightly deviated from the incident position. With this configuration, the plurality of mid-air images whose image-forming positions are slightly deviated can be displayed, and various viewing effects can be provided. As a matter of course, a case where a new optical path is formed and the other image light beam is guided to a totally different incident position is also conceivable.

It should be noted that in a case where the second display 12 is not arranged on the rear side of the second transmissive mirror 22, a total reflection mirror or the like having a transmittance of about 0% may be used as the second transmissive mirror 22. With this configuration, an amount of light of the image light beam reflected on the second transmissive mirror 22 can be increased, and a brighter mid-air image (having a higher luminance) can be displayed.

FIGS. 5 to 8 are schematic diagrams showing an example of an operation of the actuator 23. FIG. 9 is a schematic diagram showing an example of the mid-air image 70 displayed in accordance with the operation of the actuator 23.

As described above, the actuator 23 is capable of individually moving the display 10 and the first and second transmissive mirrors 21 and 22 in the direction (X direction) of the optical axis 60 (FIGS. 5 to 7). Moreover, the actuator 23 is capable of changing the angle of inclination θ of the first transmissive mirror 21 (FIG. 8). The incident position P of the image light beam 50, which enters the optical image-forming element 30, and the optical path length of the image light beam 50 from the display 10 to the optical image-forming element 30 are changed by operation of the actuator 23.

In FIG. 5, the second transmissive mirror 22 is moved by the actuator 23 in the direction (X direction) of the optical axis 60. For example, using a reference position as a reference, the second transmissive mirror 22 is moved in each of a direction (left-hand direction) away from the first display 11 and a direction (right-hand direction) to the first display 11. It is assumed that a distance by which it is movable to the left or right is d/2 and an entire distance by which it is movable is d.

When the second transmissive mirror 22 moves in the direction (left-hand direction) away from the first display 11, each of a forward path of the turned-back optical path 90 (part of the optical path 81) and a backward path (optical path 82) is extended. Therefore, the optical path length of the turned-back optical path 90 is extended by a distance twice as long as the movement distance of the second transmissive mirror 22. When the second transmissive mirror 22 moves in the direction (right-hand direction) to the first display 11, each of the forward path and the backward path of the turned-back optical path 90 is shortened. Therefore, the optical path length of the turned-back optical path 90 is shortened by a distance twice as long as the movement distance of the second transmissive mirror 22.

Therefore, as shown in FIG. 5, when the second transmissive mirror 22 moves in the left-hand direction by the distance d/2, a protruding distance of the first mid-air image 71 is extended by the double distance d (first mid-air image 71a). When the second transmissive mirror 22 moves in the right-hand direction by the distance d/2, the protruding distance of the first mid-air image 71 is shorter by the double distance d (first mid-air image 71b).

In the example shown in FIG. 5, an alphabet character E is displayed as the first mid-air image 71. Moreover, a square including two large and small circles therein is displayed as the second mid-air image 72. It is assumed that outer frames of the first and second mid-air images 71 and 72, which are shown as the broken lines, correspond to pixels at outer edges of the first and second displays 11 and 12 and the image light beam 50 is not emitted from those pixels.

In FIG. 9, a change of superimposed images when the second transmissive mirror 22 is moved in the left-hand direction is shown. When the second transmissive mirror 22 is moved in the left-hand direction, the protruding distance of the first mid-air image 71 is extended, and thus the first mid-air image 71 is displayed closer to the user. Although the size of the first mid-air image 71 itself is not changed, the first mid-air image 71 is displayed at a closer position, and thus the alphabet character E appears to be enlarged.

Regarding the second mid-air image 72, the optical path length of the second image light beam 52 does not change even when the second transmissive mirror 22 is moved. Thus, its image-forming position does not change. Therefore, the size of the second mid-air image 72 is maintained and only the character E is enlarged. The display of the superimposed images can be easily controlled in this manner.

In this embodiment, due to the configuration of the turned-back optical path 90, the protruding distance of the first mid-air image 71 becomes twice as long as the movement distance of the second transmissive mirror 22. Therefore, the protruding distance can be greatly changed by using a small amount of movement, and the size of the actuator 23 can be reduced. As a result, downsizing of the mid-air image display apparatus 100 is realized.

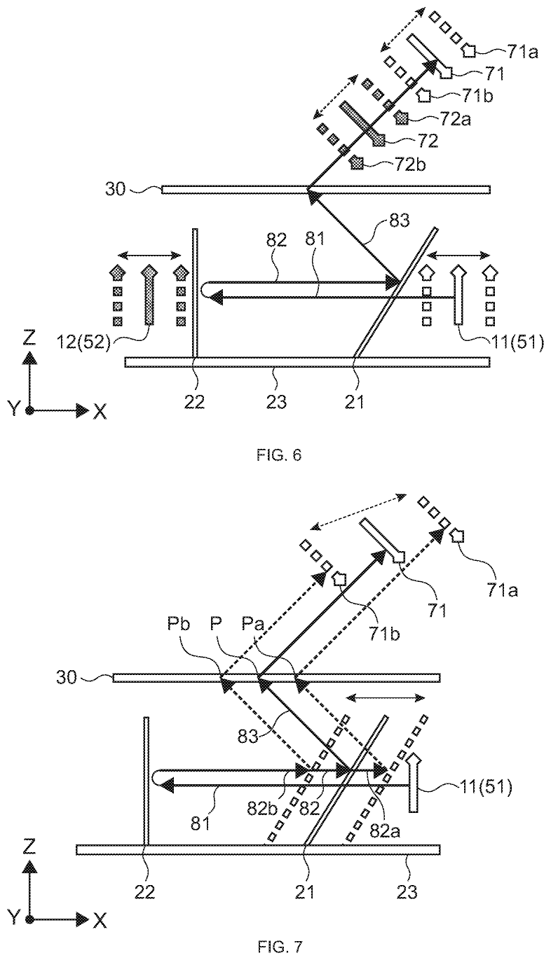

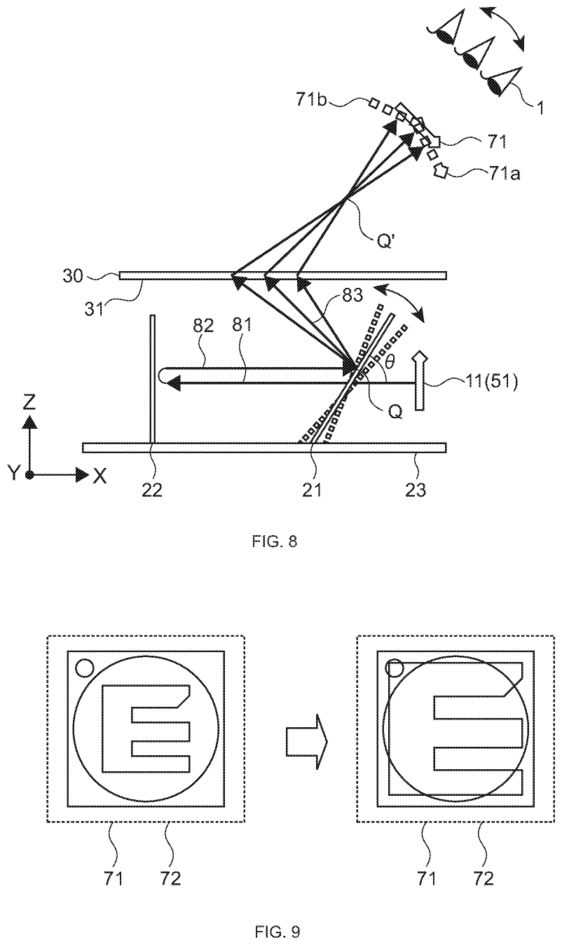

In FIG. 6, the first and second displays 11 and 12 are individually moved by the actuator 23 in the direction (X direction) of the optical axis 60. When the first display 11 moves in the direction (right-hand direction) away from the first transmissive mirror 21, the optical path length of the first image light beam 51 is extended by that movement distance. Therefore, the protruding distance of the first mid-air image 71 is also extended by the same movement distance (first mid-air image 71a).

When the first display 11 moves in the direction (left-hand direction) to the first transmissive mirror 21, the optical path length of the first image light beam 51 is shortened by that movement distance. Therefore, the protruding distance of the first mid-air image 71 is also shortened by the same movement distance (first mid-air image 71b).

When the second display 12 moves in the direction (left-hand direction) away from the second transmissive mirror 22, the optical path length of the second image light beam 52 is extended by that movement distance. Therefore, the protruding distance of the second mid-air image 72 is also extended by the same movement distance (second mid-air image 72a).

When the second display 12 moves in the direction (right-hand direction) to the second transmissive mirror 22, the optical path length of the second image light beam 52 is shortened by that movement distance. Therefore, the protruding distance of the second mid-air image 72 is also shortened by the same movement distance (second mid-air image 72b).

When the respective positions of the first and second displays 11 and 12 are changed in the X direction in this manner, the start point of the optical path of each of the first and second image light beams 51 and 52 is changed. With this configuration, the optical path length of each of the first and second image light beams 51 and 52 is changed, and the protruding distance of each of the first and second mid-air images 71 and 72 is changed by a distance corresponding to the amount of movement.

By independently moving the first display 11 and the second display 12, the superimposed images of the first mid-air image 71 and the second mid-air image 72 as viewed in the direction of the user's line of sight can be controlled and displayed with high precision, for example. For example, first of all, the second transmissive mirror 22 is moved and the position of the first mid-air image 71 is greatly changed. After that, the first and second displays 11 and 12 are moved and the respective positions of the first and second mid-air images 71 and 72 are finely adjusted. Such an operation can also be performed.

Moreover, the respective positions of the third and fourth displays 13 and 14 shown in FIG. 4 may be variable. With this configuration, the image-forming positions of the third and fourth mid-air images 73 and 74 can be controlled as appropriate. As a result, the display of the superimposed images can be controlled with high precision, and a high-level viewing experience can be provided.

In FIG. 7, the first transmissive mirror 21 is moved by the actuator 23 in the direction (X direction) of the optical axis 60. The first transmissive mirror 21 is moved in the direction (left-hand direction) away from the first display 11 or in the direction (right-hand direction) to the first display 11, for example.

It should be noted that the angle of inclination θ of the first transmissive mirror 21 is not changed.

When the first transmissive mirror 21 moves in the direction to the first display 11, the distance from the first transmissive mirror 21 to the second transmissive mirror 22 is extended. On the other hand, the distance from the first display 11 to the second transmissive mirror 22 and the distance from the first transmissive mirror 21 to the optical image-forming element 30 are not changed. Therefore, the optical path length (optical paths 81+82+83) of the first image light beam 53 from the first display 11 to the optical image-forming element 30 is extended by a distance equivalent to the amount of movement of the first transmissive mirror 21.

Moreover, when the first transmissive mirror 21 is moved toward the first display 11, the optical path 83 of the first image light beam 51 from the first transmissive mirror 21 toward the optical image-forming element 30 is translated toward the first display 11. Therefore, an incident position Pa of the first image light beam 51 on the optical image-forming element 30 is moved toward the first display 11. The amount of movement of that incident position Pa is equal to the amount of movement of the first transmissive mirror 21. As a result, as shown in FIG. 8, the first mid-air image 71a is formed at a position protruding from the moved incident position Pa by the optical path length (optical paths 81+82a+83) of the first image light beam 51.

When the first transmissive mirror 21 moves in the direction away from the first display 11 (direction to the second transmissive mirror 22), the distance from the first transmissive mirror 21 to the second transmissive mirror 22 is shortened. Therefore, the optical path length (optical paths 81+82+83) of the first image light beam 51 from the first display 11 to the optical image-forming element 30 is shortened by a distance equivalent to the amount of movement of the first transmissive mirror 21.

Moreover, an incident position Pb of the first image light beam 51 moves toward the second transmissive mirror 22 by a distance corresponding to the amount of movement of the first transmissive mirror 21. As a result, as shown in FIG. 8, the first mid-air image 71b is formed at a position protruding from the moved incident position Pb by the optical path length (optical paths 81+82b+83) of the first image light beam 51.

By moving the first transmissive mirror 21 in the X direction in this manner, the incident position of the first image light beam 51, which enters the optical image-forming element 30, and the optical path length of the first image light beam 51 from the first display 11 to the optical image-forming element 30 can be changed. With this configuration, the image-forming position of the first mid-air image 72 can be adjusted in the X direction, and the mid-air image can be displayed in a manner desired by the user.

The first display 11, the first transmissive mirror 21, the second transmissive mirror 22, and the like may be respectively moved by the actuator 23 in conjunction. With this configuration, high-level position control of sliding the image-forming position without changing a protruding distance of the mid-air image 70, for example, can be performed.

In this embodiment, the first display 11, the first transmissive mirror 21, and the second transmissive mirror 22 are arranged in the straight line. Therefore, a multi-slider or the like arranged in the X direction can be used as the actuator 23, for example, and the respective elements can be easily moved with high precision. Moreover, a compact moving mechanism can be easily realized, and downsizing of the mid-air image display apparatus 100 is realized.

In FIG. 9, the angle of inclination θ of the first transmissive mirror 21 is changed by the actuator 23. In this embodiment, the first transmissive mirror 21 is rotated about an axis, which extends in the Y direction, to both the right and the left from the angle of inclination θ (about 67.5 degrees) which is a reference. Moreover, as schematically shown in FIG. 9, the first transmissive mirror 21 is rotated using an intersection point of the first transmissive mirror 21 and the optical axis 60 as a reference. Therefore, even when the angle of inclination θ is changed, the incident position at which the first image light beam 51 enters the first transmissive mirror 21 is not changed. As a matter of course, the present technology is not limited thereto.

A range for changing the angle of inclination θ is not also limited. For example, it is defined in a manner that depends on a range of the incident angle which enables the optical image-forming element 30 to form the mid-air image. For example, it is assumed that the optical image-forming element 30 is capable of forming an image of the image light beam 50 which enters in a range of about 45 degrees±20 degrees, as the mid-air image 70. In this case, a range of ±20 degrees from the angle of inclination (about 6) which is a reference is defined as a range of change of the angle of inclination θ. As a matter of course, the present technology is not limited thereto.

When the angle of inclination θ of the first transmissive mirror 21 is changed, a direction of reflection of the first image light beam 51 reflected by the first transmissive mirror 21 (incident direction to the optical image-forming element 30) is changed. Therefore, the incident position and the incident angle of the first image light beam 51 are changed.

On the other hand, a reflection position Q at which the first image light beam 51 is reflected by the first transmissive mirror 21 is not substantially changed. Therefore, the optical path length of the first image light beam 51 is substantially equal to a difference in the optical path length from the reflection position Q of the first transmissive mirror 21 to the optical image-forming element 30. Moreover, as shown in FIG. 9, the first image light beam 51 emitted by the optical image-forming element 30 to the mid-air side passes through a symmetric position Q′ on the mid-air side, which is plane-symmetric to the reflection position Q across the optical image-forming element 30. As a result, in accordance with a change in the angle of inclination θ of the first transmissive mirror 21, the first mid-air image 71 is formed, tilted using the symmetric position Q′ on the mid-air side as a reference.

For example, in a case where the angle of inclination θ is increased, the first image light beam 51 is reflected at a more acute angle and enters the incident surface 31 of the optical image-forming element 30 at a shallower angle. The first image light beam 51 emitted at the shallower angle from the optical image-forming element 30 is formed at a lower position (first mid-air image 71a). Moreover, for example, in a case where the angle of inclination θ is reduced, the first image light beam 51 is reflected at a more obtuse angle and enters the incident surface 31 of the optical image-forming element 30 at a deeper angle. The first image light beam 51 emitted from the optical image-forming element 30 at the deeper angle is formed at a higher position (first mid-air image 71b).

As described above, the first mid-air image 71 is tilted downward when the angle of inclination θ of the first transmissive mirror 21 is increased and the first mid-air image 71 is tilted upward when the angle of inclination θ is reduced. That is, by changing the angle of inclination θ of the first transmissive mirror 21, a display angle of the first mid-air image 71 to the user's viewpoint 1 can be adjusted. With this configuration, the display of the mid-air image can be controlled with high precision in accordance with the direction of the line of sight (viewpoint angle) and the like, which are desired by the user.

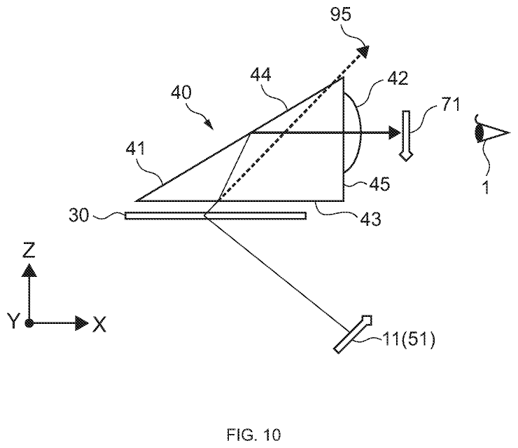

FIG. 10 is a schematic diagram for describing the optical path in the image-forming optical system 40. In the configuration shown in FIG. 10, for easy understanding of the optical path of the first image light beam 51 and the like in the image-forming optical system 40, a configuration in which the first display 11 is arranged tilted at the angle of about 45 degrees without the emission optical system 20 is shown. Moreover, an arrow 95 as the broken-line of FIG. 10 is the optical path of the first image light beam 51 in a case where the image-forming optical system 40 is not arranged and a top end of the arrow corresponds to the image-forming position of the first mid-air image 71 (position symmetric to the first display 11).

In this embodiment, the first image light beam 51 emitted from the optical image-forming element 30 passes through the prism 41 and the lens unit 42, which are included in the image-forming optical system 40, and is emitted toward the user's viewpoint 1.

In the prism 41, the incident surface 43 and the emission surface 45 are connected to each other at a substantially right angle and the reflection surface 44 is provided. The reflection surface 44 includes respective sides of the emission surface 45 and the incident surface 43, which are on a side opposite to a side at which those are connected to each other. In FIG. 10, the prism 41 is arranged including the emission surface 45 on a right-hand side such that the incident surface 43 is parallel to the optical image-forming element 30. The first image light beam 51 emitted from the first display 11 enters the optical image-forming element 30 and is emitted in such a direction that the first image light beam 51 emitted from the optical image-forming element 30 and the first image light beam 51 entering the optical image-forming element 30 are plane-symmetric to each other with respect to the optical image-forming element 30. The first image light beam 51 emitted from the optical image-forming element 30 enters the incident surface 43 of the prism 41.

The first image light beam 51 which enters the incident surface 43 of the prism 41 is refracted on an interface of the prism 41 (incident surface 43) in accordance with a refractive index of the material of the prism 41. The refracted first image light beam 51 travels toward the reflection surface 44, is totally reflected by the reflection surface 44, and enters the emission surface 45 at a substantially right angle. Therefore, the first image light beam 51 is emitted from the emission surface 45 of the prism 41 via the lens unit 42 in substantially parallel to the X direction. It should be noted that loss of the luminance and the like of the first mid-air image 71 is sufficiently prevented by totally reflecting the first image light beam 51.

As described above, the optical path of the first image light beam 51 is bent in substantially parallel to the X direction through refraction and total reflection at the prism 41. With this configuration, the optical path of the first image light beam 51 can be easily controlled. That is, the image-forming position of the first mid-air image 71 can be easily changed to a desired position. It should be noted that a direction in which the optical path of the first image light beam 51 is bent and the like are not limited. For example, the first image light beam can be guided in a desired direction by setting the refractive index of the prism 41, the angle of the reflection surface, and the like as appropriate. Further, the shape of the prism 41 is not also limited to the triangular prism. For example, a design such that total reflection occurs multiple times may be performed.

FIG. 11 is a diagram for describing the lens unit 42 arranged on the optical path of the first image light beam 51 emitted from the optical image-forming element 30. A of FIG. 11 is a diagram showing an example of the optical path of the image light beam 50 in a case where a convex lens 46 is arranged. B of FIG. 11 is a diagram showing an example of the optical path of the image light beam 50 in a case where a concave lens 47 is arranged. It should be noted that in FIG. 11, for easy understanding, only the convex lens 46 and the concave lens 47 are shown and the prism 41 is omitted.

In A and B of FIG. 11, the optical path (optical axis of the first image light beam 51) passing through the center of the first image light beam 51 is shown. It is assumed that with respect to the optical image-forming element 30, an optical path on an incident side is an incident optical path 61 and an optical path on an emission side is an emission optical path 62. In the example shown in A of FIG. 11, the convex lens 46 is arranged to be orthogonal to the emission optical path 62. Light entering the optical image-forming element 30 along the incident optical path 61 enters the convex lens 46 along the emission optical path 62 plane-symmetric to the incident optical path 61.

The first image light beam 51 entering the convex lens 46 is converged using a focal point (not shown) of the convex lens 46 as a reference. As a result, an image of the first image light beam 51 is formed on the side of the optical image-forming element 30 as compared to the image-forming position in a case where the convex lens 46 is not arranged. In A of FIG. 11, the first mid-air image 71 in a case where the convex lens 46 is not arranged and a first mid-air image 71′ in a case where the convex lens 46 is arranged are shown. As it can also be seen by comparing the first mid-air images 71 and 71′ with each other, a protruding distance of the first mid-air image 71′ is shortened due to the arrangement of the convex lens 46. Moreover, the size of the first mid-air image 71′ is reduced along with convergence of the first image light beam 51. Therefore, the image size is reduced.

In the example shown in B of FIG. 11, the concave lens 47 is arranged to be orthogonal to the emission optical path 62. Therefore, the first image light beam 51 emitted from the optical image-forming element 30 and entering the concave lens 47 is radiated using a focal point (not shown) of the concave lens 47 as a reference. As a result, an image of the first image light beam 51 is formed on a side away from the optical image-forming element 30 (user side) as compared to the image-forming position in a case where the concave lens 47 is not arranged. By comparing the first mid-air image 71 in the case where the concave lens 47 is not arranged with the first mid-air image 71′ in the case where the concave lens 47 is arranged, it can be seen that the protruding distance of the first mid-air image 71′ is extended due to the arrangement of the concave lens 47. Moreover, the size of the first mid-air image 71′ increases along with radiation of the first image light beam 51. Therefore, the image size is increased.

By arranging the convex lens 46 and the concave lens 47 on the optical path of the image light beam 50 emitted from the optical image-forming element 30 in order to form the mid-air image 70 as described above, the image-forming position of the image light beam 50 can be changed. Moreover, the size of the mid-air image 70 and the like can be controlled with high precision by utilizing refraction of the convex lens 46 and the concave lens 47.

It should be noted that the convex lens 46 and the concave lens 47 are not limited and various lenses may be used. For example, a spherical lens, a Fresnel lens, a non-spherical lens, and a varifocal lens in which the focal distance is adjustable, and the like may be used as appropriate. Further, the present technology is not limited to scaling of the mid-air image 70 and various types of optical control may be performed on the mid-air image 70. For example, a lens that corrects distortion and the like of an image generated by refraction and the like on the incident surface 43 of the prism 41 shown in FIG. 9 may be mounted. With this configuration, the mid-air image 70 can be displayed with very high precision.

Referring back to FIG. 10, the first image light beam 51 changed in accordance with the characteristics of the lens unit 42 is emitted in the X direction and an image of the first image light beam 51 is formed as the first mid-air image 71 in the air to which the user's viewpoint 1 is directed. With this configuration, the user can view the first mid-air image 71 in the direction (X direction) parallel to the optical image-forming element 30. By controlling the image-forming position of the mid-air image 70 and the like through the prism 41 and the lens unit 42 in this manner, the mid-air image 70 can be displayed in a manner that depends on the user's viewpoint 1, and a high-level viewing experience and the like can be provided.

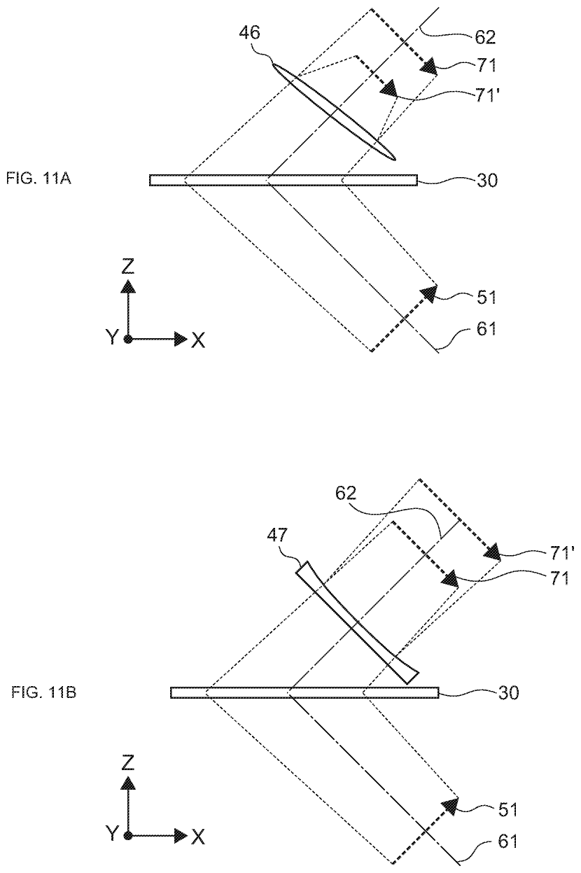

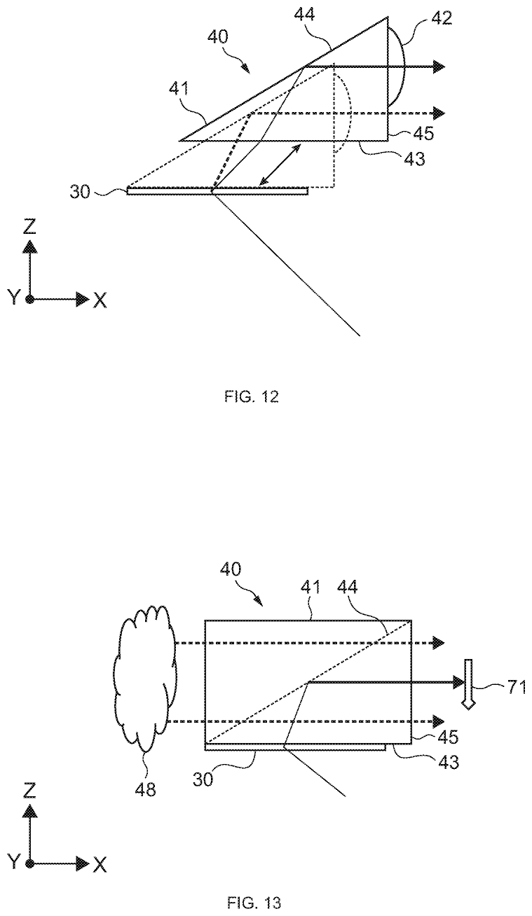

As shown in FIG. 12, the image-forming optical system 40 may be movable by any moving mechanism (not shown). With this configuration, the image-forming position of the first mid-air image 71 can be easily changed. For example, as shown in FIG. 12, the image-forming optical system 40 is translated along the XZ-plane. The broken lines show the image-forming optical system 40 before movement and the optical path of the first image light beam 51. The solid lines show the image-forming optical system 40 after movement and the optical path of the first image light beam 51.

As shown in FIG. 12, the image-forming optical system 40 is moved upward (direction away from the optical image-forming element) while the state in which the incident surface 43 of the prism 41 and the optical image-forming element 30 are parallel to each other is maintained. Moreover, the image-forming optical system 40 is moved toward the emission surface 45 of the prism 41. In such translation, an angle of refraction on the incident surface 43 of the prism 41, an angle of total reflection (incident angle+angle of reflection) on the reflection surface 44, and the like are maintained. Therefore, the first image light beam 51 which is emitted from the emission surface 45 via the lens unit 42 travels in the X direction and does not change before and after movement. On the other hand, the position at which it is reflected on the reflection surface 44 is shifted upward. Therefore, the image-forming position of the first mid-air image 71 is also shifted upward. In this manner, the image-forming position of the first mid-air image 71 can be easily controlled with high precision.

As a matter of course, the manner of changing the position of the image-forming optical system 40 is not limited to the translation. For example, an angle of installation and the like may be changed. With this configuration, the optical path of the first image light beam 51 can be easily bent, and the first mid-air image 71 can be displayed at an angle desired by the user.

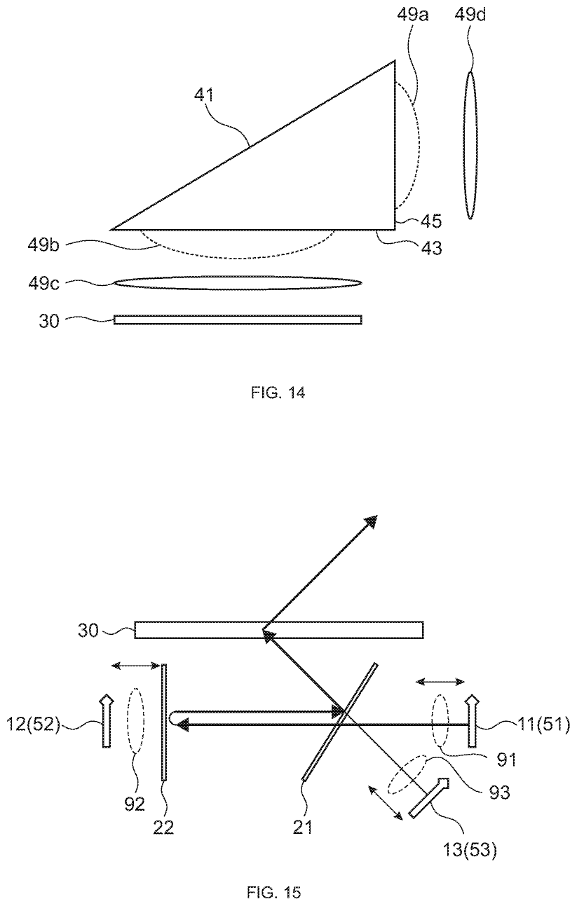

FIGS. 13 and 14 are schematic diagrams showing other configuration examples of the image-forming optical system 40. In this image-forming optical system 40, two prisms 41 are joined with each other. The joined surface is used as a reflection surface 44 having a transmittance. For example, the reflection surface 44 having a transmittance can be configured by depositing a thin film such as a metal thin film and a dielectric multi-layer film having predetermined reflectance and transmittance.

By configuring the reflection surface 44 having a transmittance, the first mid-air image 71 is displayed to be superimposed on a background 48 as viewed from the user's viewpoint. Therefore, the first mid-air image 71 can be displayed in a see-through state. For example, augmented-reality experience and the like using the mid-air image 70 can be provided, and a high-quality viewing experience can be provided.

It should be noted that the condition of total reflection on the reflection surface 44 can be enhanced by forming a thin film or the like having no transmittance on the reflection surface 44 of the image-forming optical system 40 shown in FIG. 13. With this configuration, for example, even if the image light beam 50 enters the reflection surface 44 at a deep angle, the image light beam 50 can be totally reflected and the optical path of the image light beam 50 can be bent at a desired angle.

In the image-forming optical system 40 shown in FIG. 14, a plurality of lenses 49 are provided as the lens unit 42. First of all, a first lens 49a and a second lens 49b are provided on the emission surface 45 and the incident surface 43 of the prism 41. The first lens 49a and the second lens 49b are integrally formed with a prism 41. With this configuration, control of the image-forming position and magnification of the mid-air image 70 and the like can be performed by utilizing refraction and the like of the lenses as described above.

Nanoimprint technique, cutting technique, and the like are used for working and molding the first and second lenses 49a and 49b. Alternatively, any technique by which the prism 41 can be worked may be used. Since the first and second lenses 49a and 49b are formed integrally with the prism 41, it is unnecessary to perform mechanical alignment in assembling the apparatus. Moreover, position deviation and the like due to vibration and shock are suppressed, and the apparatus having a high reliability can be provided.

Moreover, a third lens 49c is provided between the first lens 49a and the optical image-forming element 30. A fourth lens 49d is provided on a front side (user side) with respect to the second lens 49b. With this configuration, for example, various types of optical aberration caused by the first and second lenses 49a and 49b can be corrected and the mid-air image 70 can be increased/decreased in size.

In order to realize scaling of the mid-air image 70 and the like, a lens and the like can also be provided inside the apparatus.

FIG. 15 is a schematic diagram showing a configuration example in a case where lenses are arranged inside the apparatus. In the example shown in FIG. 15, first to third lens units 91 to 93 are respectively provided on emission sides of the first to third displays 11 to 13. The first lens unit 91 is arranged between the first display 11 and the first transmissive mirror 21 and the second lens unit 92 is arranged between the second display 12 and the second transmissive mirror 22. The third lens unit 93 is arranged between the third display 13 and the first transmissive mirror 21.

Configuration of each of the first to third lens units 91 to 93 is not limited. The first to third lens units 91 to 93 may arbitrarily include one or more various lenses, other optical elements, and the like. The first to third lens units 91 to 93 correspond to an internal optical unit which is arranged on the optical path of the image light beam from the emitter to the image-forming element.

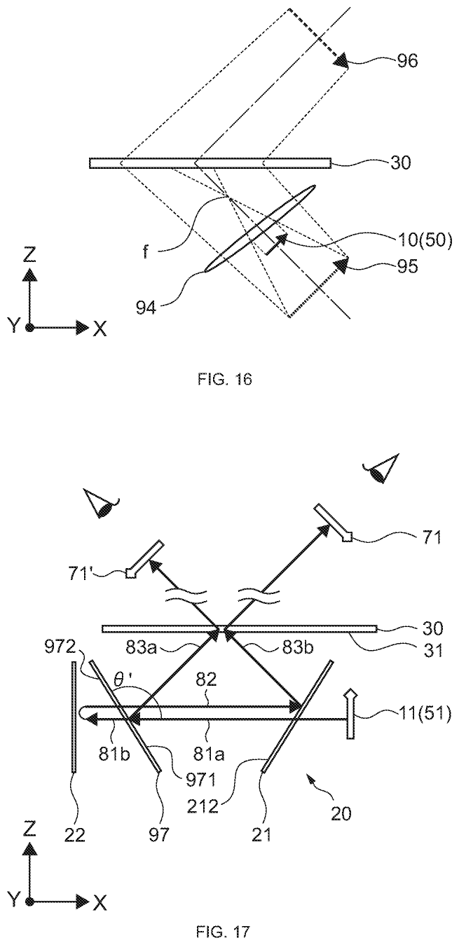

FIG. 16 is a schematic diagram for describing the lens unit which is arranged inside the apparatus. In FIG. 16, a basic configuration including a display 10 that emits an image light beam 50 and a convex lens 94 as the lens unit is shown. The display 10 emits the image light beam 50 toward an optical image-forming element 30. The convex lens 94 is arranged between the optical image-forming element 30 and the display 10. The convex lens 94 is arranged such that a distance from the display 10 is shorter than a focal distance (virtual-image optical system).

The image light beam 50 emitted from the display 10 is converged directed to a focal point f of the convex lens 94. Therefore, a virtual image 95 of the image light beam 50, which is enlarged, is formed at the back of the display 10 as viewed from the optical image-forming element 30. As a result, a mid-air image 96 of the virtual image 95 of the image light beam 50 is formed at a position plane-symmetric to the virtual image 95 of the image light beam 50 across the optical image-forming element 30.

By displaying the virtual image 95 of the image light beam 50 as the mid-air image 96 through the virtual-image optical system in this manner, the mid-air image 70 can be displayed in an enlarged state. Moreover, since the position of the virtual image 95 is on a rear side with respect to the display 10, the mid-air image 96 of the virtual image 95 is displayed protruding by that amount. Alternatively, the mid-air image 70 can be easily reduced in size and corrected by changing the type, arrangement, and the like of the lens as appropriate. In addition, a function of zooming the mid-air image 70 can be realized by moving the convex lens 94 in an optical-axis direction.

By arranging the first to third lens units 91 to 93 as shown in FIG. 15, various effects including a change of the image-forming positions of the first to third mid-air images, increase/decrease in image size, distortion correction, and the like can be provided. Moreover, by setting the first to third lens units 91 to 93 to be movable in the optical-axis direction, a function of zooming the first to third mid-air images and the like can be realized.

The method for moving the respective lens units and the like are not limited. For example, by using the actuator 23 including the above-mentioned multi-slider and the like, the first and second lens units 91 and 92 may be moved. With this configuration, a zoom function and the like can be realized while the apparatus size is reduced. Moreover, a varifocal lens in which the focal distance or the like is variable and the like may be used instead of moving the respective lens units. With this configuration, a zoom function and the like can be easily realized without adding a moving mechanism or the like.

By providing the lens unit to face each of the plurality of displays inside the apparatus in this manner, the plurality of mid-air images can be individually increased/decreased in size and aberration can be corrected. With this configuration, each mid-air image can be independently controlled, and various viewing effects can be realized.

FIG. 17 is a schematic diagram showing another configuration example of the emission optical system 20. In FIG. 17, a third transmissive mirror 97 is arranged between the first and second transmissive mirrors 21 and 22 described with reference to FIG. 1. In this embodiment, the third transmissive mirror 97 corresponds to another reflector element.

The third transmissive mirror 97 includes a first surface 971 directed to the first transmissive mirror 21 and a second surface 972 on a side opposite thereto. The third transmissive mirror 97 causes part of light entering each surface to pass therethrough and reflects other part of light.

The third transmissive mirror 97 is arranged tilted at a predetermined angle about an axis, which extends in the Y direction, such that the first surface 971 is directed upward. In this embodiment, the third transmissive mirror 97 is arranged to be plane-symmetric to the first transmissive mirror 21 with respect to the XZ-plane. That is, the third transmissive mirror 97 is arranged such that an angle of inclination θ′ with respect to the X direction is 135 degrees.

A first image light beam 51 emitted from the first display 11 in the X direction passes through the first transmissive mirror 21 and enters the first surface 971 of the third transmissive mirror 97 (optical path 81a). Part of the first image light beam 51 entering the first surface 971 of the third transmissive mirror 97 is reflected at an angle of about 45 degrees toward the incident surface 31 of the optical image-forming element 30 (optical path 83a). Other part of light passes through the third transmissive mirror 97 and enters the second transmissive mirror 22 as it is (optical path 81b).

The first image light beam 51 entering the second transmissive mirror 22 is reflected in the X direction, passes through the third transmissive mirror 97 again, and enters the second surface 212 of the first transmissive mirror 21 (optical path 82). The first image light beam 51 entering the second surface 212 of the first transmissive mirror 21 is reflected toward the incident surface 31 of the optical image-forming element 30 (optical path 83b).

As shown in FIG. 17, the first image light beam 51 reflected on the third transmissive mirror 97 is emitted from the optical image-forming element 30 in an upper left direction and a first mid-air image 71′ is formed. A protruding distance of the first mid-air image 71′ is equal to a distance (optical paths 81a+83a) obtained by summing up a distance (optical path 81a) from the first display 11 to the third transmissive mirror 97 and a distance (optical path 83a) from the third transmissive mirror 97 to the optical image-forming element 30.

Further, the first image light beam 51 reflected on the first transmissive mirror 21 is emitted from the optical image-forming element 30 in an upper right direction and a first mid-air image 71 is formed. A protruding distance of the first mid-air image 71 is equal to a distance (optical paths 81a+81b+82+83b) obtained by summing up a distance (optical paths 81a+81b) from the first display 11 to the second transmissive mirror 22, a distance (optical path 82) from the second transmissive mirror 22 to the first transmissive mirror 21, and a distance (optical path 83b) from the first transmissive mirror 21 to the optical image-forming element 30.

By arranging the third transmissive mirror 97 between the first and second transmissive mirrors 21 and 22 in this manner, two mid-air images (first mid-air images 71 and 71′) are formed from the first image light beam 51 emitted from the first display 11. That is, the plurality of mid-air images 50 can be generated from the single display 10. The two mid-air images are displayed in directions opposite to each other. Therefore, for example, the mid-air images can be displayed to two users with the apparatus put therebetween. With this configuration, a plurality of users can enjoy the mid-air images.

As described above, in the mid-air image display apparatus 100 according to this embodiment, the first image light beam 51 entering the first surface 211 of the first transmissive mirror 21 and passing through the first transmissive mirror 21 is reflected by the second transmissive mirror 22 to the second surface 212 of the first transmissive mirror 21. The first image light beam 51 reflected to the second surface 212 of the first transmissive mirror 21 is reflected by the second surface 212 to the optical image-forming element 30. By configuring the optical path of the first image light beam 51 in this manner, downsizing of the apparatus can be achieved as described above mainly with reference to FIG. 2 and the like. As a result, a compact mid-air image display apparatus 100 capable of displaying the mid-air image can be realized.

A method of bending the optical path of the image light beam 50 by the use of the total reflection mirror or the like is conceivable as a method of making the apparatus capable of displaying the mid-air image 70 compact. However, in the case of only bending the optical path, it is necessary to increase the distance between the total reflection mirror and the emission position (display) and the distance between the total reflection mirror and the optical image-forming element 30 in order to increase the protruding distance of the mid-air image 70. Therefore, it is difficult to reduce the apparatus size.

In this embodiment, as shown in FIG. 1 and the like, the turned-back optical path 90 is configured. Therefore, the protruding distance of the mid-air image can be sufficiently increased while the apparatus size is reduced. Moreover, the range in which the protruding distance of the mid-air image can be changed can be extended. As a result, for example, a powerful expression in which the mid-air image greatly protrudes can be made and the like, and a compact mid-air image display apparatus 100 capable of providing a very high-quality viewing experience can be realized.

Moreover, the configurations of the first and second transmissive mirrors 21 and 22 according to this embodiment are very simple, and the other configurations including the display, the moving mechanism, and the like can be easily introduced. With this configuration, a zoom function such as scaling of the mid-air image 70, a function of displaying the plurality of mid-air images to be superimposed on each other can be easily realized, and very high extensibility is provided. As a result, a compact mid-air image display apparatus 100 having various functions can be realized.

### Second Embodiment

A mid-air image display apparatus of a second embodiment according to the present technology will be described. Hereinafter, descriptions of portions similar to the configurations and actions in the mid-air image display apparatus 100, which have been described in the embodiment above, will be omitted or simplified.

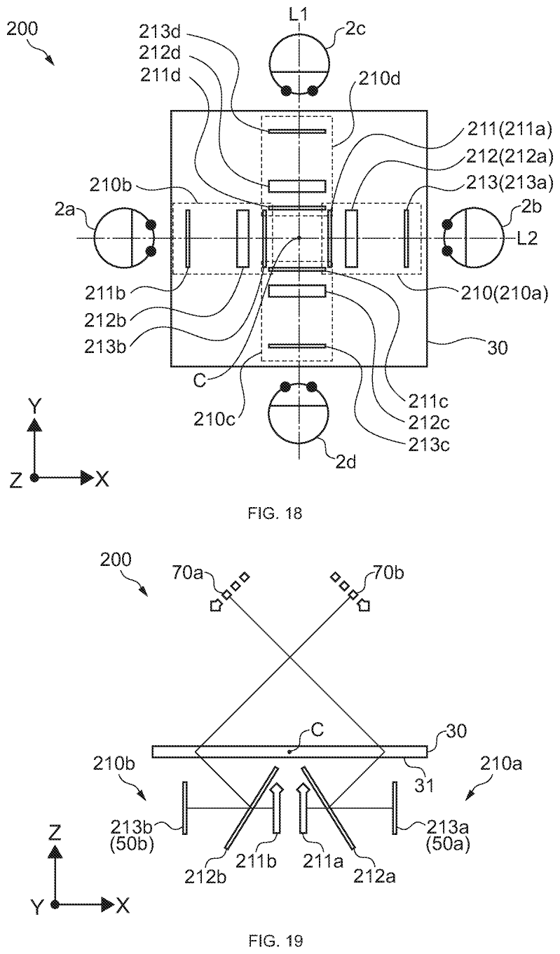

FIGS. 18 and 19 are schematic diagrams showing a configuration example of a mid-air image display apparatus 200 according to this embodiment. In FIG. 19, a configuration example inside an apparatus which is the mid-air image display apparatus 200 as viewed from a side surface of the apparatus (as viewed in the Y direction) is shown.

In the mid-air image display apparatus according to this embodiment, mid-air image display units 210 are configured. The mid-air image display units 210 include displays 211 and first and second transmissive mirrors 212 and 213. The first and second transmissive mirrors 212 and 213 are for guiding image light beams, which are emitted from those displays, to an optical image-forming element. Then, the plurality of mid-air image display units 210 are arranged using a position of an optical image-forming element 30 as a reference.

In this embodiment, four, first to fourth mid-air image display units 210 (210a, 210b, 210c, 210d) are arranged. The respective mid-air image display units 210 have configurations substantially the same as one another. The mid-air image display units 210 each include a display 211 (211a, 211b, 211c, 211d), a first transmissive mirror 212 (212a, 212b, 212c, 212d), and a second transmissive mirror 213 (213a, 213b, 213c, 213d) which are arranged in the straight line. In this embodiment, the configuration shown in FIG. 2 is employed.

As shown in FIG. 18, a first reference axis L1 and a second reference axis L2 are set using a center point C of the optical image-forming element 30 as a reference. The first reference axis L1 extends in the X direction. The second reference axis L2 extends in the Y direction orthogonal thereto. The first and second mid-air image display units 210a and 210b are arranged to face each other along the first reference axis L1. The third and fourth mid-air image display units 210c and 210d are arranged to face each other along the second reference axis L2.

As shown in FIG. 19, the displays 211a and 211b are arranged near the center point C of the optical image-forming element 30. The displays 211a and 211b are arranged to emit image light beams 50a and 50b toward outer edges of the optical image-forming element 30 along the first reference axis L1. On a front side (emission side) of the display 211a, the first transmissive mirror 212a and the second transmissive mirror 213a are arranged in the stated order. On a front side (emission side) of the display 211b, the first transmissive mirror 212b and the second transmissive mirror 213b are arranged in the stated order.

Therefore, the first transmissive mirror 212a, the display 211a, the display 211b, and the first transmissive mirror 212b are arranged in the stated order along the first reference axis L1 between the second transmissive mirror 213a of the first mid-air image display unit 210a to the second transmissive mirror 213b of the second mid-air image display unit 210b.

An image of the image light beam 50a emitted by the display 211a of the first mid-air image display unit 210a is formed by the optical image-forming element 30 as a mid-air image 70a. An image of the image light beam 50b emitted by the display 211b of the second mid-air image display unit 210b is formed by the optical image-forming element 30 as a mid-air image 70b. The mid-air images 70a and 70b are displayed in the directions opposite to each other along the first reference axis L1. The mid-air images 70a and 70b are viewed by users 2a and 2b facing each other along the first reference axis L1.

The third and fourth mid-air image display units 210c and 210d are also arranged along the second reference axis L2 in a manner substantially similar to the configuration shown in FIG. 19. With this configuration, an image of an image light beam 50c emitted from the third mid-air image display unit 210c is formed as a mid-air image 70c. An image of an image light beam 50d emitted from a fourth mid-air image display unit 210d is formed as a mid-air image 70d. The mid-air images 70c and 70d are displayed in the directions opposite to each other along the second reference axis L2. The mid-air images 70c and 70d are viewed by users 2c and 2d facing each other along the second reference axis L2.

By arranging the plurality of mid-air image display units 210 using the position of the optical image-forming element 30 as a reference in this manner, the mid-air images 70 independent from each other at multiple viewpoints can be displayed. With this configuration, the mid-air images 70 can be displayed to the plurality of users by commonly using the single optical image-forming element 30, for example. As a result, an increase in size of the apparatus can be suppressed and the cost can be reduced. Moreover, the use of a plurality of optical image-forming elements 30 which are joined with each other can be avoided, and image distortion and the like, which would be caused in the joint, can be prevented.

It should be noted that the number, arrangement, and the like of mid-air image display units 210 are not limited. For example, a required number of mid-air image display units may be arranged in a manner that depends on the assumed number of users and the like. Moreover, for example, an arrangement in which the optical paths of the respective mid-air image display units 210 cross one another can also be realized.

With this configuration, it is possible to sufficiently make use of the single optical image-forming element 30. For example, an apparatus capable of displaying the mid-air images at the same time in various directions can be produced at low cost.

In addition, the first and second transmissive mirrors and the like may be used commonly to the plurality of mid-air image display units 210. That is, a plurality of image light beams 50 emitted from the plurality of displays 211 may be guided by one first transmissive mirror 212 or one second transmissive mirrors 213 to the optical image-forming element.

### Third Embodiment

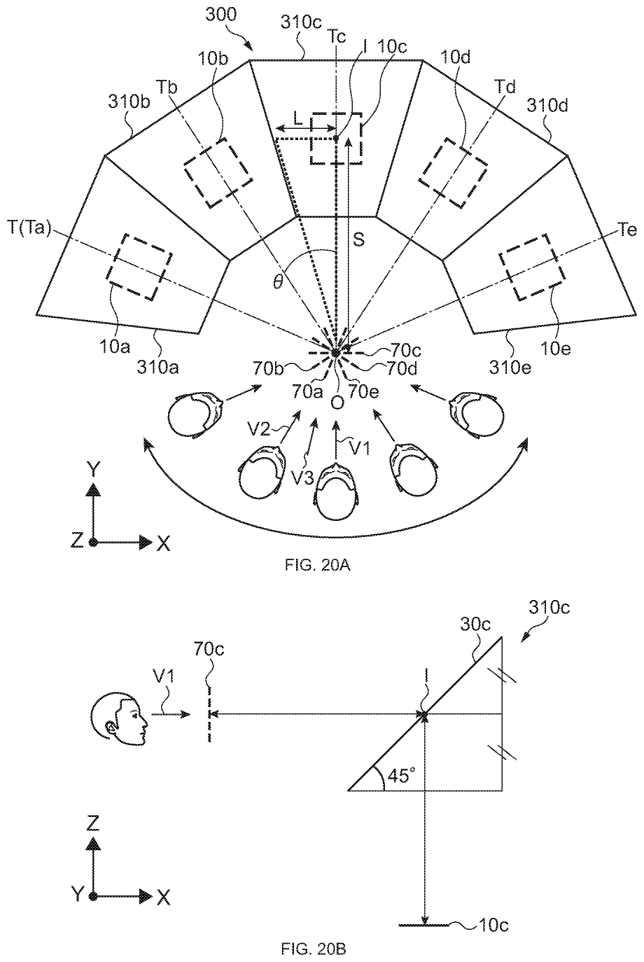

FIG. 20 is a schematic diagram showing a configuration example of a mid-air image display apparatus according to a third embodiment. A of FIG. 20 is a top view as a plurality of mid-air image display apparatuses are viewed in the Z direction. B of FIG. 20 is a side view as a third mid-air image display unit positioned at the center of A of FIG. 20 is viewed in the X direction. It should be noted that hereinafter, the XY-plane is a horizontal plane and the Z direction is the upper and lower directions, though the present technology is not limited thereto.

In a mid-air image display apparatus 300, mid-air image display units 310 are configured. The mid-air image display units 310 include displays 10 and optical image-forming elements 30. The optical image-forming elements 30 are for forming the mid-air image 70. Then, the plurality of mid-air image display units 310 are arranged using a reference point O as the center.

As shown in A of FIG. 20, in this embodiment, the five, first to fifth mid-air image display units 310 (310a, 310b, 310c, 310d, 310e) are arranged. As shown in B of FIG. 20, the third mid-air image display unit 310c positioned at the center includes an optical image-forming element 30c arranged tilted at about 45 degrees from the horizontal plane (XY-plane) and a display 10c arranged below the optical image-forming element 30c to be parallel to the XY-plane.

The five, first to fifth mid-air image display units 310 (310a, 310b, 310c, 310d, 310e) have configurations substantially the same as one another. That is, the mid-air image display units 310 each include an optical image-forming element 30 (30a, 30b, 30c, 30d, 30e) arranged tilted at about 45 degrees from the horizontal plane (XY-plane) and a display 10 (10a, 10b, 10c, 10d, 10e) arranged below the optical image-forming element to be parallel to the XY-plane.

The five, first to fifth mid-air image display units 310 (310a, 310b, 310c, 310d, 310e) are arranged to the right in the stated order along the circumference having the reference point O as the center such that the respective optical image-forming element 30 are in contact with one another with no clearances. As shown in A of FIG. 20, an axis passing through the center of each of the mid-air image display units 310 as viewed from above is a reference axis T (Ta, Tb, Tc, Td, Te). The five, first to fifth mid-air image display units 310 (310a, 310b, 310c, 310d, 310e) are arranged such that the respective reference axes T cross one another at the reference point O. Therefore, the respective mid-air image display units 310 are arranged in an arena form as a whole. Therefore, the optical image-forming element 30 has a trapezoid shape having shorter sides closer to the reference point O and longer sides farther from the reference point.

The image light beams 50 are emitted from the displays 10, which are arranged on the respective reference axes T, in the Z direction. The emitted image light beams 50 are emitted by the optical image-forming elements 30, which are arranged on the same reference axes T, in directions in which the reference axes T extend, i.e., the horizontal direction. Then, images of the respective image light beams 50 are formed at the reference point O as vertical mid-air images 70. As shown in FIG. 20, the respective mid-air images 50 (50a, 50b, 50c, 50d, 50e) are arranged to overlap one another at an angle θ, using the reference point O as the center. That angle θ is equal to an arrangement angle (angle between the reference axes T next to each other) of the optical image-forming elements 30 next to each other. It should be noted that first to fifth mid-air images 70 (70a, 70b, 70c, 70d, 70e) have all the same display contents.

The optical path length of the image light beam 50 inside the apparatus (distance from the display 10 to the optical image-forming element) is set to be equal to the distance from the reference point O to an emission point I of the optical image-forming element 30 such that the mid-air image 70 is displayed by each mid-air image display unit 310 at the reference point O. The present technology is not limited to a case where the reference point O is initially set, and other mid-air image display units 310 may be arranged using a position of a mid-air image 70 displayed by the single mid-air image display unit 310 arranged in any attitude as the reference point.

As shown in A of FIG. 20, the size of each optical image-forming element 30 is set to such a size that at least the displays 10 do not depart from the top view (A of FIG. 20). It is assumed that a distance from the emission point I of the optical image-forming element 30 (=incident point at which the image light beam enters the apparatus) to the reference point O is S. Moreover, it is assumed that a distance from the emission point I to a boundary with the optical image-forming element 30 next to it in a direction orthogonal to the reference axis is L. Then, the following relationship is established between the angle θ at which the mid-air images 70 are superimposed on each other and the distances S and L.

S=L/tan(θ/2) (1)

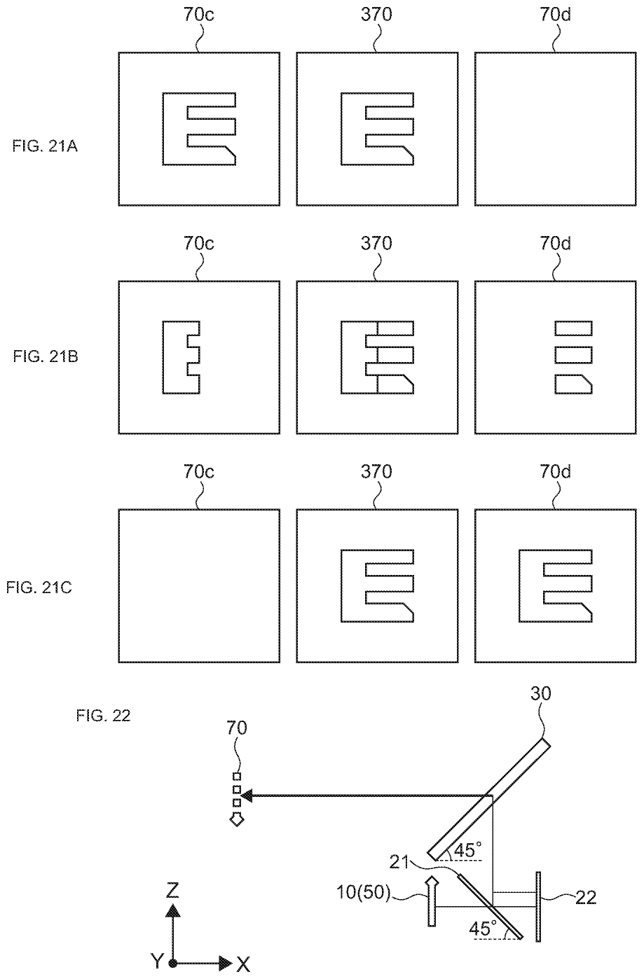

FIG. 21 is a schematic diagram for describing how the mid-air images 70 displayed at the reference point O are seen. A of FIG. 21 is a diagram for describing the mid-air images when the reference point O is viewed from a viewpoint V1 in front of the third mid-air image display unit 310c. B of FIG. 21 is a diagram for describing the mid-air images when the reference point O is viewed from a viewpoint V2 in front of the fourth mid-air image display unit 310d. C of FIG. 21 is a diagram for describing the mid-air images when the reference point O is viewed from a viewpoint V3 in middle of the viewpoints V1 and V2. It should be noted that the alphabet E is displayed as the first to fifth mid-air images 70 (70a, 70b, 70c, 70d, 70e).

In A to C of FIG. 21, the leftmost diagrams are diagrams showing how the third mid-air image 70c is seen. The rightmost diagrams are diagrams showing how the fourth mid-air image 70d is seen. The center diagrams are diagrams showing a mid-air image 370 which can be visually recognized when looking at the reference point O. Therefore, the user becomes aware of the mid-air image 370 shown at the center. The user does not become aware of how the third and fourth mid-air images 70c and 70d are seen.

When the user looks at the reference point O from the viewpoint V1, the third mid-air image 70c is properly displayed without loss. On the other hand, in the fourth mid-air image 70d displayed tilted at the angle θ, no character E is displayed. As a result, the character E of the third mid-air image 70c is properly displayed at the reference point.

When the user looks at the reference point O from the viewpoint V2, the fourth mid-air image 70d is properly displayed without loss. On the other hand, in the third mid-air image 70c displayed tilted at the angle θ, no character E is displayed. As a result, the character E of the fourth mid-air image 70d is properly displayed at the reference point.

When the user looks at the reference point O from the viewpoint V3, the user is at a position deviated to the left by about θ/2 with respect to the third mid-air image 70c. Therefore, a right half of the character E is hidden and a left half of the character E is displayed. The user is at a position deviated to the right by about θ/2 with respect to the fourth mid-air image 70d. Therefore, the left half of the character E is hidden and the right half of the character E is displayed. By those third and fourth mid-air images 70c and 70d being combined, the character E is properly displayed at the reference point O. It is also established in any viewpoint between the viewpoints V1 and V2, and the character E is constantly properly displayed even if the viewpoint is moved between the viewpoints V1 and V2.

In this manner, in this embodiment, for the single mid-air image 70, the range of angle in which it can be visually recognized is defined. If it departs from that range of angle, the mid-air image 70 is lost and it becomes difficult to properly visually recognize it. In this embodiment, the plurality of mid-air image display units 310 are arranged in an arena form. Therefore, even if it departs from the range of angle for the single mid-air image 70, in which it can be visually recognized, the lost part is complemented by the next mid-air image. Therefore, as a whole, the range of angle in which it can be visually recognized can be greatly extended. For example, in the example shown in FIG. 20, the angle of about 40 from the right-hand side of the range of angle for the first mid-air image 70a, in which it can be visually recognized, to the left-hand side of the range of angle for the fifth mid-air image 70e, in which it can be visually recognized, is in the range of angle in which it can be visually recognized.

For example, it is assumed that the range of angle for the single mid-air image 70, in which it can be visually recognized, is ±20 degrees while the front (normal direction) of the mid-air image 70 is set as 0 degrees. The plurality of mid-air image display units 310 are arranged such that the next mid-air image can be visually recognized if it exceeds 20 degrees. With this configuration, for example, the range of angle in which it can be visually recognized can also be extended to about ±180 degrees.

The angle θ at which the mid-air images 70 are superimposed on each other, i.e., the angle of arrangement of the optical image-forming element 30 may be arbitrarily defined in a range in which a lost of the mid-air image due to such a viewpoint movement can be complemented. In the example shown in FIG. 21, the angle at which the next mid-air image 70 becomes invisible is set as the angle θ. The present technology is not limited thereto. For example, it may be arbitrarily set on the basis of the range of angle for the single mid-air image 70, in which it can be visually recognized, and the like. For example, by using Expression (1) above, a configuration for realizing a desired angle θ can be easily made.

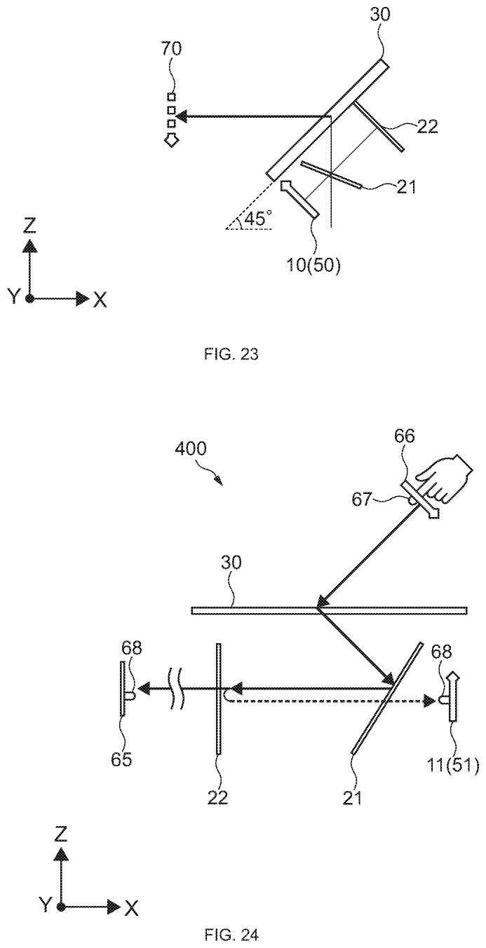

FIGS. 22 and 23 are schematic diagrams showing other configuration examples of the mid-air image display unit. In the examples shown in FIGS. 22 and 23, mid-air image display units are configured. The mid-air image display units each include a display 10, an optical image-forming element 30 for forming the mid-air image 370, and first and second transmissive mirrors 21 and 22 for guiding the image light beam 50 emitted from the display 10 to that optical image-forming element 30. As described above mainly with reference to FIG. 2 and the like, the display 10 and the first and second transmissive mirrors 21 and 22 are arranged in the straight line and a turned-back optical path is configured.

In FIG. 22, the display 10 and the second transmissive mirror 22 are arranged in the Z direction. Then, the first transmissive mirror 21 is arranged tilted on the side of the optical image-forming element 30 at an angle of about 45 degrees. With this configuration, the image light beam 350 enters the optical image-forming element 30 in the Z direction and the mid-air image 70 is vertically displayed. The configuration in FIG. 23 is substantially the same as the configuration in the case where the entire mid-air image display apparatus 100 described above with reference to FIG. 2 according to the first embodiment is tilted at about 45 degrees. Also in this case, the mid-air image 70 can be vertically displayed.

In either cases, the turned-back optical path is configured. Therefore, a reduction in size of the mid-air image display unit 310 can be achieved. As a result, a degree of freedom for arrangement of the plurality of mid-air image display units 310 can be improved and the size of the entire mid-air image display apparatus can also be sufficiently reduced. As a matter of course, the present technology is not limited to the configurations shown in FIGS. 22 and 23. The mid-air image display apparatus 300 capable of providing various viewing experiences may be configured by using the prism and the like, the plurality of displays 10, which have been described in the first embodiment, and the like.

The arrangement method for the mid-air image display units 310 is not also limited. For example, a configuration in which the optical image-forming elements 30 are not next to each other may be realized. Moreover, the mid-air images 70 formed at different protruding distances may be displayed at the reference point O. With this configuration, the degree of freedom for arrangement of the mid-air image display unit and the like can be enhanced, and, for example, it is possible to set the reference point O at various places and display the mid-air image 70 having a wide range in which it can be visually recognized.

### Other Embodiments

The present technology is not limited to the above-mentioned embodiments and various other embodiments can be made.

FIG. 24 is a schematic diagram showing a configuration example of a mid-air image display apparatus according to another embodiment. A mid-air image display apparatus 400 includes a first display 11 and first and second transmissive mirrors 21 and 22 which are arranged in the straight line. Moreover, the mid-air image display apparatus 400 includes a sensor unit 65 arranged outside the second transmissive mirror (on the side opposite to the first transmissive mirror 21).

The sensor unit 65 is provided at a position symmetric to the first display 11, using the second transmissive mirror 22 as a reference. That is, the sensor unit 65 is provided at such a position that a distance to the second transmissive mirror 22 is substantially equal to the distance from the first display 11 to the second transmissive mirror 22. An optical sensor such as a photo-sensor is used as the sensor unit 65, for example.

For example, as shown in FIG. 24, it is assumed that a touch operation is input in an operation screen 66 flowing as the mid-air image. Then, an image of a user's finger 67 travels in an opposite direction on the optical path of the first image light beam 51 and is guided to the second transmissive mirror 22. Then, it passes through the second transmissive mirror 22 and an image 68 of the user's finger 67 is formed at the sensor unit 65. It should be noted that in FIG. 24, a portion penetrating an operation screen 66 is schematically shown as the finger 67 and the image 68 of the finger 67.

The sensor unit 65 detects the motion or the like of the formed image 68 of the finger, to thereby detect a user's touch operation on the mid-air image. With this configuration, the user can perform an operation input or the like using the mid-air image, and a touch operation can be performed in the air without touching an actual operation panel or the like.

By arranging the sensor unit 65 at a position at which the image 68 of the user's finger 67 is formed, i.e., a position symmetric to the first display 11, the motion or the like of the image 68 of the finger 67 can be detected with high precision. On the other hand, in the allowable range of the detection accuracy, the position of the sensor unit 65 can also be deviated from the image-forming position of the image 68 of the finger 67.

For example, by moving the sensor unit 65 closer to the second transmissive mirror 22, downsizing of the apparatus can be achieved.

Moreover, the image-forming position of the image 68 of the finger 67 can also be changed by using the optical element such as the lens.

Moreover, the sensitivity or the like of the sensor unit 65 can also be set to correct the deviation of the image-forming position.

With this configuration, the touch operation function or the like can be easily realized while sufficiently reducing the apparatus size.

As shown in FIG. 24, the image 68 of the user's finger 67 is also formed on the first display 11. Therefore, for example, by utilizing the display or the like including a built-in photo-sensor as the first display 11, a user's touch operation on the mid-air image (operation screen 66) can be detected without arranging the sensor unit 65.

In a case where the display including the built-in photo-sensor is used instead of the sensor unit 65, it is very useful for downsizing the apparatus. However, since a display including a built-in photo-sensor doesn't have a lot of circulation and most of those displays are expensive, there is a possibility that the apparatus cost may increase.

In a case where the sensor unit 65 is arranged outside the second transmissive mirror 22, a general photo-sensor or the like having a lot of circulation can be used. Therefore, very inexpensive touch operation function and the like can be introduced. On the other hand, the apparatus size slightly increases. For example, in view of those points, which configuration is to be employed may be detected. As a matter of course, the touch operation detection accuracy can also be improved by using both of the sensor unit 65 and the display including the built-in photo-sensor.

In the above-mentioned embodiment, the angle of inclination θ of the first transmissive mirror is changed and the first image-forming position of the mid-air image or the like is changed (see FIG. 9). The present technology is not limited thereto. The angle of inclination of the second transmissive mirror may be changed. With this configuration, for example, the optical path of the mid-air image or the like can be changed and the image-forming position and display angle of the mid-air image can be changed. For example, the display angle of the mid-air image which is changed by tilting the second transmissive mirror can be finely adjusted by changing the angle of inclination of the first transmissive mirror.

Moreover, the emission direction of the image light beam (angle of inclination of the display) may be changed. In a case of changing the angle of inclination of the display, the optical path of the image light beam can be increased by little angle adjustment, for example. Therefore, it becomes unnecessary to use a large-scale angle adjustment mechanism and the like, and an increase in apparatus size and an increase in cost can be suppressed. Further, the respective angles of inclination of the first transmissive mirror, the second transmissive mirror, and the display may be changed in conjunction. With this configuration, the optical path of the image light beam or the like can be finely adjusted, and the image-forming position and display angle of the mid-air image can be controlled with high precision.

At least two of the characteristic portions according to the present technology, which have been described above can also be combined.

That is, various characteristic portions described above in the respective embodiments may be arbitrarily combined across the respective embodiments. Moreover, the various effects described above are merely exemplary and are not limitative. Moreover, other effects may be provided.

It should be noted that the present technology can also take configurations as follows.

(1) An image display apparatus, including:

an emitter that emits an image light beam;

an image-forming element that forms an image of the entering image light beam as a mid-air image;

a first reflector element that includes a first surface and a second surface and that causes at least part of the image light beam, which is emitted from the emitter and enters the first surface, to pass therethrough and reflects at least part of the image light beam, which enters the second surface, to the image-forming element; and

a second reflector element that reflects at least part of the image light beam, which enters the first surface and passes through the first reflector element, to the second surface of the first reflector element.

(2) The image display apparatus according to (1), in which the second reflector element reflects at least part of the image light beam, which enters the first surface of the first reflector element, passes through the first reflector element, and is emitted in a predetermined direction, in the predetermined direction.
(3) The image display apparatus according to (2), in which the emitter emits the image light beam to the first surface of the first reflector element in the predetermined direction.
(4) The image display apparatus according to (2) or (3), in which

the emitter, the first reflector element, and the second reflector element are arranged in the stated order in the predetermined direction.

(5) The image display apparatus according to any one of (2) to (4), in which

the image-forming element includes an incident surface, which the image light beam enters, and

the predetermined direction is a direction parallel to the incident surface.

(6) The image display apparatus according to any one of (2) to
(5), further including

one or more other emitters that each emit another image light beam.

(7) The image display apparatus according to (6), in which

the one or more other emitters include the other emitter that is arranged on a side opposite to the first reflector element of the second reflector element and emits the other image light beam to the second reflector element in the predetermined direction, and

the second reflector element causes at least part of the other image light beam emitted by the other emitter to pass therethrough and emits the at least part of the other image light beam to the second surface of the first reflector element.

(8) The image display apparatus according to (6) or (7), in which

the one or more other emitters include the other emitter that is arranged between the first reflector element and the second reflector element, emits the other image light beam to the second reflector element in the predetermined direction, and causes the image light beam passing through the first reflector element and the other image light beam reflected by the second reflector element to pass therethrough.

(9) The image display apparatus according to any one of (6) to (8), in which

the one or more other emitters include the other emitter that is arranged on a side opposite to the image-forming element with respect to the first reflector element and emits the other image light beam to the first surface of the first reflector element in an emission direction of the image light beam reflected by the second surface of the first reflector element.

(10) The image display apparatus according to any one of (2) to (9), further including

a changer that changes an image-forming position of the mid-air image which is formed by the image-forming element.

(11) The image display apparatus according to (10), in which

the image-forming element forms the mid-air image at a position depending on an incident position of the image light beam which enters the image-forming element and an optical path length of the image light beam from the emitter to the image-forming element, and

the changer is capable of changing at least one of the incident position of the image light beam or the optical path length of the image light beam.

(12) The image display apparatus according to (10) or (11), in which

the changer is capable of changing a position of at least one of the emitter, the first reflector element, or the second reflector element.

(13) The image display apparatus according to any one of (10) to (12), in which

the emitter, the first reflector element, and the second reflector element are arranged in the stated order in the predetermined direction, and

the changer moves at least one of the emitter, the first reflector element, or the second reflector element in the predetermined direction.

(14) The image display apparatus according to any one of (10) to (13), in which

the changer is capable of changing at least one of an emission direction of the image light beam of the emitter, an angle of reflection of the image light beam of the first reflector element, or an angle of reflection of the image light beam of the second reflector element.

(15) The image display apparatus according to any one of (1) to (14), further including

another reflector element that is arranged between the first reflector element and the second reflector element, reflects part of the image light beam, which passes through the first reflector element, to the image-forming element, and causes other part of light the image light beam, which passes through the first reflector element, to pass therethrough.

(16) The image display apparatus according to any one of (1) to (15), further including

a plurality of image display units, each of which is a unit including the emitter and the first reflector element and the second reflector element for guiding the image light beam emitted by the emitter to the image-forming element, the plurality of image display units being arranged using a position of the image-forming element as a reference.

(17) The image display apparatus according to (16), in which

the plurality of image display units each include the image-forming element for forming an image of the image light beam emitted by the emitter as the mid-air image, and

the plurality of image display units are arranged in such a manner that the mid-air images respectively formed by the plurality of image display units are superimposed on each other at a predetermined angle, using a predetermined reference point as a center.

(18) The image display apparatus according to any one of (1) to (17), further including

a sensor unit that detects a touch operation on the mid-air image.

(19) The image display apparatus according to any one of (1) to (18), in which

the changer includes an external optical unit which is arranged on an optical path of the image light beam which is emitted from the image-forming element.

(20) The image display apparatus according to any one of (1) to (19), in which

the changer includes an internal optical unit which is arranged on an optical path of the image light beam from the emitter to the image-forming element.

(21) An image display unit, comprising:

an emitter that emits an image light beam;

an image-forming element that forms an image of the entering image light beam as a mid-air image;

a first reflector element that includes a first surface and a second surface and that causes at least part of the image light beam, which is emitted from the emitter and enters the first surface, to pass therethrough and reflects at least part of the image light beam, which enters the second surface, to the image-forming element that forms an image of the entering image light beam as a mid-air image; and

a second reflector element that reflects at least part of the image light beam, which enters the first surface and passes through the first reflector element, to the second surface of the first reflector element.

### REFERENCE SIGNS LIST

10, 11 to 14 display
20 emission optical system
21 first transmissive mirror
211 first surface
212 second surface
22 second transmissive mirror
23 actuator
30 optical image-forming element
31 incident surface
40 image-forming optical system
41 prism
42, 92 lens unit
50 image light beam
51 first image light beam
52 second image light beam
65 sensor unit
70 mid-air image
71 first mid-air image
72 second mid-air image
210, 310 mid-air image display unit
100, 200, 300, 400 mid-air image display apparatus

1. An image display apparatus, comprising:
an emitter that emits an image light beam;
an image-forming element that forms an image of the entering image light beam as a mid-air image;
a first reflector element that includes a first surface and a second surface and that causes at least part of the image light beam, which is emitted from the emitter and enters the first surface, to pass therethrough and reflects at least part of the image light beam, which enters the second surface, to the image-forming element; and
a second reflector element that reflects at least part of the image light beam, which enters the first surface and passes through the first reflector element, to the second surface of the first reflector element.

2. The image display apparatus according to claim 1, wherein
the second reflector element reflects at least part of the image light beam, which enters the first surface of the first reflector element, passes through the first reflector element, and is emitted in a predetermined direction, in the predetermined direction.

3. The image display apparatus according to claim 2, wherein
the emitter emits the image light beam to the first surface of the first reflector element in the predetermined direction.

4. The image display apparatus according to claim 2, wherein
the emitter, the first reflector element, and the second reflector element are arranged in the stated order in the predetermined direction.

5. The image display apparatus according to claim 2, wherein
the image-forming element includes an incident surface, which the image light beam enters, and
the predetermined direction is a direction parallel to the incident surface.

6. The image display apparatus according to claim 2, further comprising
one or more other emitters that each emit another image light beam.

7. The image display apparatus according to claim 6, wherein
the one or more other emitters include the other emitter that is arranged on a side opposite to the first reflector element of the second reflector element and emits the other image light beam to the second reflector element in the predetermined direction, and
the second reflector element causes at least part of the other image light beam emitted by the other emitter to pass therethrough and emits the at least part of the other image light beam to the second surface of the first reflector element.

8. The image display apparatus according to claim 6, wherein
the one or more other emitters include the other emitter that is arranged between the first reflector element and the second reflector element, emits the other image light beam to the second reflector element in the predetermined direction, and causes the image light beam passing through the first reflector element and the other image light beam reflected by the second reflector element to pass therethrough.

9. The image display apparatus according to claim 6, wherein
the one or more other emitters include the other emitter that is arranged on a side opposite to the image-forming element with respect to the first reflector element and emits the other image light beam to the first surface of the first reflector element in an emission direction of the image light beam reflected by the second surface of the first reflector element.

10. The image display apparatus according to claim 2, further comprising
a changer that changes an image-forming position of the mid-air image which is formed by the image-forming element.

11. The image display apparatus according to claim 10, wherein
the image-forming element forms the mid-air image at a position depending on an incident position of the image light beam which enters the image-forming element and an optical path length of the image light beam from the emitter to the image-forming element, and
the changer is capable of changing at least one of the incident position of the image light beam or the optical path length of the image light beam.

12. The image display apparatus according to claim 10, wherein
the changer is capable of changing a position of at least one of the emitter, the first reflector element, or the second reflector element.

13. The image display apparatus according to claim 10, wherein
the emitter, the first reflector element, and the second reflector element are arranged in the stated order in the predetermined direction, and
the changer moves at least one of the emitter, the first reflector element, or the second reflector element in the predetermined direction.

14. The image display apparatus according to claim 10, wherein
the changer is capable of changing at least one of an emission direction of the image light beam of the emitter, an angle of reflection of the image light beam of the first reflector element, or an angle of reflection of the image light beam of the second reflector element.

15. The image display apparatus according to claim 1, further comprising
another reflector element that is arranged between the first reflector element and the second reflector element, reflects part of the image light beam, which passes through the first reflector element, to the image-forming element, and causes other part of light the image light beam, which passes through the first reflector element, to pass therethrough.

16. The image display apparatus according to claim 1, further comprising
a plurality of image display units, each of which is a unit including the emitter and the first reflector element and the second reflector element for guiding the image light beam emitted by the emitter to the image-forming element, the plurality of image display units being arranged using a position of the image-forming element as a reference.

17. The image display apparatus according to claim 16, wherein
the plurality of image display units each include the image-forming element for forming an image of the image light beam emitted by the emitter as the mid-air image, and
the plurality of image display units are arranged in such a manner that the mid-air images respectively formed by the plurality of image display units are superimposed on each other at a predetermined angle, using a predetermined reference point as a center.

18. The image display apparatus according to claim 1, further comprising
a sensor unit that detects a touch operation on the mid-air image.

19. The image display apparatus according to claim 1, wherein
the changer includes an external optical unit which is arranged on an optical path of the image light beam which is emitted from the image-forming element.

20. The image display apparatus according to claim 1, wherein
the changer includes an internal optical unit which is arranged on an optical path of the image light beam from the emitter to the image-forming element.
